(19) United States
(12) Patent Application Publication
(10) Pub. No.: US 2016/0208980 A1
(43) Pub. Date: Jul. 21, 2016

(54) Support System Having a Precast Concrete Riser and A Method for Fabricating Same

(71) Applicant: Ronald Swaney, Old Lyme, CT (US)

(72) Inventor: Ronald Swaney, Old Lyme, CT (US)

(21) Appl. No.: 14/600,991

(22) Filed: Jan. 20, 2015

(51) Int. Cl. F16M 11/22; F16M 7/00

(52) U.S. Cl. CPC F16M 11/22; F16M 7/00

(57) ABSTRACT

A precast concrete support riser and method for supporting an article is provided and includes a first precast concrete wall, a second precast concrete wall, a third precast concrete wall, and a fourth precast concrete wall, wherein each of the first concrete wall, second concrete wall, third concrete wall and fourth concrete wall includes a wall front surface, a wall rear surface, a wall top, a wall bottom, a first end and a second end. The precast concrete support riser further includes a plurality of securing articles and a plurality of mounting articles, wherein the plurality of mounting articles are configured to be securely associated with the wall rear surface of each of the first concrete wall, second concrete wall, third concrete wall and fourth concrete wall and wherein the plurality of securing articles are configured to securely associate with the plurality of mounting articles.

RELATED U.S. APPLICATION DATA

This application is related to and claims benefit of priority of U.S. Provisional Patent Application Ser. No. 61/929,020 (Attorney Docket No. 20060-00004), filed Jan. 18, 2014, the contents of which are incorporated by reference herein in its entirety.

### FIELD OF THE INVENTION

The present invention relates generally to precast concrete supports and more particularly to a easily implemented precast concrete riser support and a method for creating the precast concrete riser.

### BACKGROUND OF THE INVENTION

In recent years, substantial weather events, such as Superstorm Sandy, have caused lengthy power outages and thus created a substantial increase in the demand for standby generators. As a result, many commercial and residential property owners are having these standby generators permanently installed on their property.

Currently, there are many types of generator systems available that are designed for permanent installation. Such generator systems typically include a generator that is positioned on a concrete pad which is used to stably support the generator. This concrete pad/slab is typically installed at the existing grade level and, because these pads/slabs are only 3″ or 4″ inches thick, the generator is not typically raised high enough off of the ground to protect the generator from snow/water buildup and storm runoff. This is undesirable and, despite the hazard moisture poses to a generator, the precast concrete pads supporting the generators are often installed directly on the ground because the current methods for locating and supporting generators at a safer height require constructing an elaborate support structure, which is time consuming and expensive. In fact, in some cases, generators are required to be installed at a certain elevation above ground level. In these cases, the more elaborate support structure is required, thereby increasing installation time and cost.

It is known that support structures are required to have a substantial bearing strength because the combined weight of the generator and the concrete pad require is substantial. As such, to achieve the required strength, a typical supporting structure is constructed from reinforced masonry units or cast-in-place concrete. This is expensive, time consuming and in some cases, cost prohibitive. The supporting structure could be constructed from wood if the members were sufficiently sized, but such members would be so heavy that they would probably require heavy equipment to handle and set in place. In addition, wood—even pressure treated wood—is subject to rot and decay after being in contact with the ground moisture. Additionally, designing any structural member out of wood is problematic because the irregularities in the material make standard calculations unreliable.

A number of factors currently prohibit manufacturing a supporting structure off site. One factor is that current precast concrete support structures would almost certainly crack during transport to the installation site or from the settlement after installation. Another factor is that, although mortar and concrete have excellent compressive strength, these materials are weak in tension. Therefore, a masonry block wall is also likely to sustain substantial damage during transport. Additionally, although a wood structure would most likely be able to be transported without damage, wood is a poor material choice due to rot and decay. Wood is also not a practical material for a support device because the generator manufacturer typically requires that combustible materials be kept a substantial distance away from the generator.

### SUMMARY OF THE INVENTION

A support riser for supporting a generator is provided and includes a plurality of walls, wherein each of the plurality of walls includes a wall front surface, a wall rear surface, a wall top, a wall bottom, a first end and a second end. The support riser further includes a plurality of securing articles and a plurality of mounting articles, wherein the plurality of mounting articles are configured to be securely associated with the wall rear surface of the plurality of walls and wherein the plurality of securing articles are configured to securely associate with the plurality of mounting articles. A support riser for supporting a generator, comprising: a plurality of walls, wherein each of the plurality of walls includes a wall front surface, a wall rear surface, a wall top, a wall bottom, a first end, and a second end; a plurality of securing articles; and a plurality of mounting articles, wherein the plurality of mounting articles are configured to be securely associated with the wall rear surface of the plurality of walls and wherein the plurality of securing articles are configured to securely associate with the plurality of mounting articles.

A precast concrete support riser for supporting a generator is provided and includes a first precast concrete wall, a second precast concrete wall, a third precast concrete wall, and a fourth precast concrete wall, wherein each of the first precast concrete wall, second precast concrete wall, third precast concrete wall, and fourth precast concrete wall includes a wall front surface, a wall rear surface, a wall top, a wall bottom, a first end, and a second end. The precast concrete support riser further includes a plurality of securing articles and a plurality of mounting articles, wherein the plurality of mounting articles are configured to be securely associated with the wall rear surface of each of the first precast concrete wall, second precast concrete wall, third precast concrete wall, and fourth precast concrete wall and wherein the plurality of securing articles are configured to securely associate with the plurality of mounting articles.

A method for assembling and implementing a precast concrete support article is provided, wherein the precast concrete support article includes a first precast concrete wall, a second precast concrete wall, a third precast concrete wall and a fourth precast concrete wall. The method includes identifying a location for the precast concrete support article, positioning the first precast concrete wall, second precast concrete wall, third precast concrete wall and fourth precast concrete wall at the location, associating the first and third precast concrete walls with the second and fourth precast concrete walls such that the first precast concrete wall, second precast concrete wall, third precast concrete wall and fourth precast concrete wall form a quadrilateral structure having an inner cavity, associating an article support pad with the first precast concrete wall, second precast concrete wall, third precast concrete wall, and fourth precast concrete wall such that the article support pad is located proximate the top of the first precast concrete wall, second precast concrete wall, third precast concrete wall, and fourth precast concrete wall and locating an article to be supported on the article support pad.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a left hand perspective view of precast concrete riser supporting a precast concrete slab for use with a generator, in accordance with an embodiment of the present invention.

FIG. 2 is a right hand perspective view of the precast concrete riser of FIG. 1.

FIG. 3A is a cross-sectional view of the precast concrete riser of FIG. 1.

FIG. 3B is a top down view of the precast concrete riser of FIG. 1, without the precast concrete slab.

FIG. 3C is a front view of the interior side of one of the wall sections of the precast concrete riser of FIG. 1.

FIG. 4 is a top down view of the precast concrete riser of FIG. 1, without the precast concrete slab.

FIG. 5 is a top down interior view of the precast concrete riser showing the mounting articles of the wall sections of the precast concrete riser of FIG. 1.

FIG. 6A is a top down interior view of the precast concrete riser showing a securing article being associated with the mounting articles of the wall sections of the precast concrete riser of FIG. 1.

FIG. 6B is a side view of the securing article of FIG. 6A for use with the mounting articles of the wall sections of the precast concrete riser of FIG. 1.

FIG. 6C is a side view of a mounting article for the wall sections of the precast concrete riser of FIG. 1 for use with the securing articles of FIG. 6B, in accordance with one embodiment of the invention.

FIG. 6D is a side view of a mounting article for the wall sections of the precast concrete riser of FIG. 1 for use with the securing articles of FIG. 6B, in accordance with another embodiment of the invention.

FIG. 7 is a front view of the interior of the precast concrete riser showing a securing article securely associated with the mounting articles of the wall sections of the precast concrete riser of FIG. 1.

FIG. 8 is a front view of the interior of the precast concrete riser showing a securing article securely associated with the mounting articles of the wall sections of the precast concrete riser of FIG. 1.

FIG. 9 is a front view of the interior side of one of the wall sections of a precast concrete riser, in accordance with another embodiment.

FIG. 10A is a top down view of an assembled precast concrete riser having the wall sections of FIG. 9, without the precast concrete slab.

FIG. 10B is a top down view of the assembled precast concrete riser of FIG. 10A, without the precast concrete slab and showing the wall sections securely associated with an opposing wall section.

FIG. 10C is a side view and sectional view of a securing article for use with the wall sections of the precast concrete riser of FIG. 9.

FIG. 11 is an operational block diagram illustrating a method for assembling a precast concrete riser, in accordance with one embodiment of the invention.

FIG. 12A shows a side view of a fabrication platform used to fabricate the precast concrete riser of FIG. 1, in accordance with one embodiment.

FIG. 12B shows a top down side view of a forming cavity of the fabrication platform used to fabricate the precast concrete riser of FIG. 1.

FIG. 12C shows a top down side view of a forming cavity of the fabrication platform used to fabricate the precast concrete riser of FIG. 1, with the displacing article in the first configuration.

FIG. 12D shows a top down side view of a forming cavity of the fabrication platform used to fabricate the precast concrete riser of FIG. 1, with the displacing article in the second configuration.

FIG. 12E shows a top down view of a forming cavity of the fabrication platform used to fabricate the precast concrete riser of FIG. 1, showing a dowel for locating the mounting articles.

FIG. 12F shows a front side view of a forming member, in accordance with one embodiment of the invention.

FIG. 12G shows a front view of the forming member of FIG. 12F.

FIG. 13 shows a top down side view of concrete being located in the forming cavity of the fabrication platform used to fabricate the precast concrete riser of FIG. 1.

FIG. 14 shows a top down side view of concrete located in the forming cavity of the fabrication platform used to fabricate the precast concrete riser of FIG. 1, after the concrete was floated and while the concrete reinforcement is being installed.

FIG. 15 shows a top down side view of a color agent being applied to the concrete located in the forming cavity of the fabrication platform used to fabricate the precast concrete riser of FIG. 1.

FIG. 16 shows a top down side view of a color agent being applied to the concrete located in the forming cavity of the fabrication platform used to fabricate the precast concrete riser of FIG. 1.

FIG. 17 shows a top down side view of the concrete located in the forming cavity of the fabrication platform used to fabricate the precast concrete riser of FIG. 1 being floated after the color agent has been applied.

FIG. 18 shows a from side view of the forming member of FIG. 12F, being used to form a pattern in the concrete.

FIG. 19 shows a from side view of the forming member of FIG. 12F, being used to form a pattern in the concrete.

FIG. 20 side view showing the displacing articles in the second configuration to remove the precast concrete walls from the forming cavity.

FIG. 21 is an operational block diagram illustrating a method for fabricating the walls of a precast concrete riser, in accordance with one embodiment of the invention

### DETAILED DESCRIPTION OF THE INVENTION

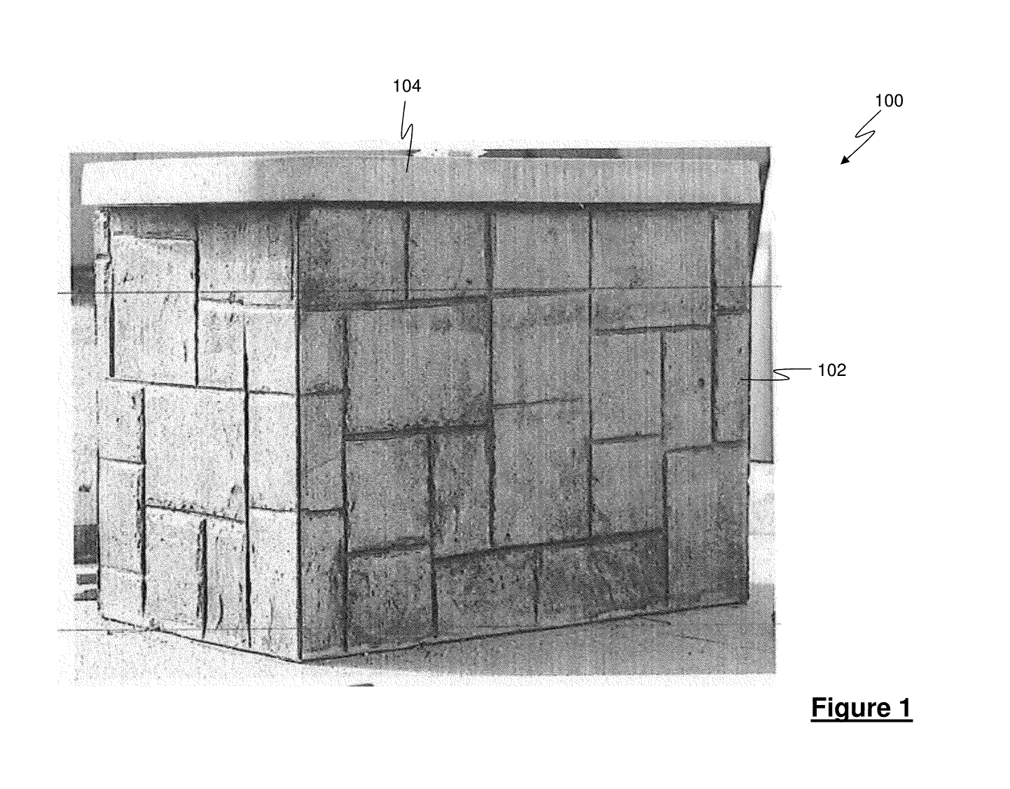

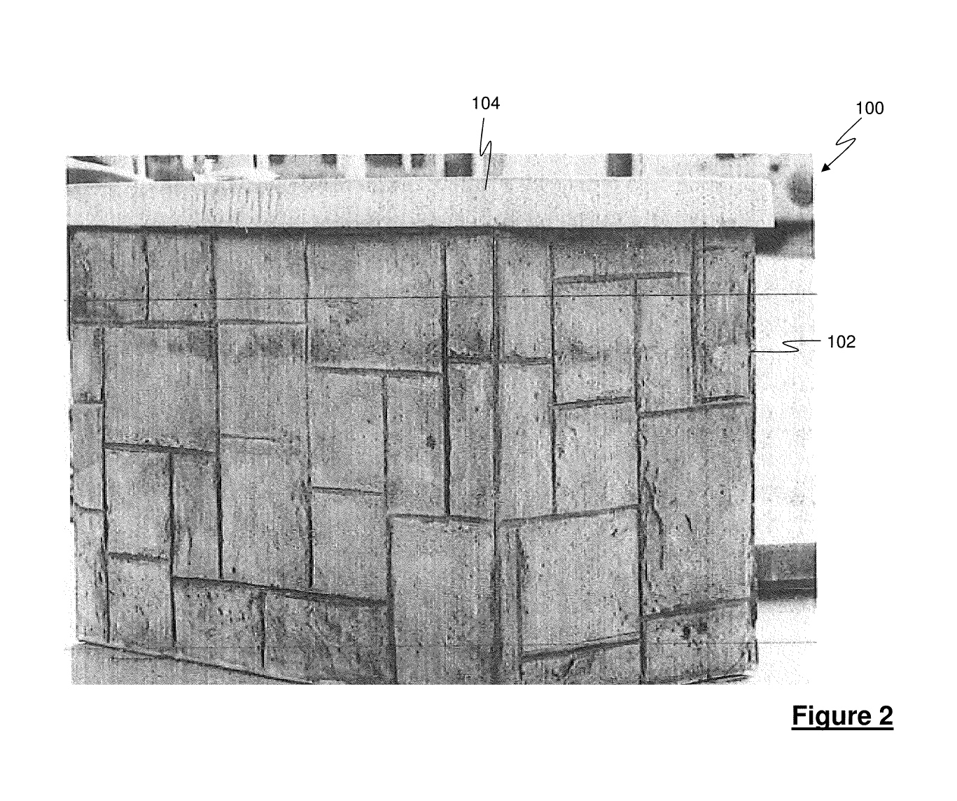

It should be appreciated that the present invention includes a support system 100 having a precast concrete riser 102 that is quick and inexpensive to construct and that can be transported safely, economically, and without damage to the concrete and may be assembled on-site if desired. Referring to FIG. 1 and FIG. 2, the support system 100 having the precast concrete riser 102 is shown supporting an article support pad 104, in accordance with one embodiment of the invention. It should be appreciated that the precast concrete riser 102 includes a plurality of wall sections, wherein the number of wall sections selected as desired and suitable to the desired end purpose. For example, the number of wall sections used may be based on the desired loading of the support system 100, a desired design and/or the landscape (and/or surrounding structures) of the area in which the support system is to be located.

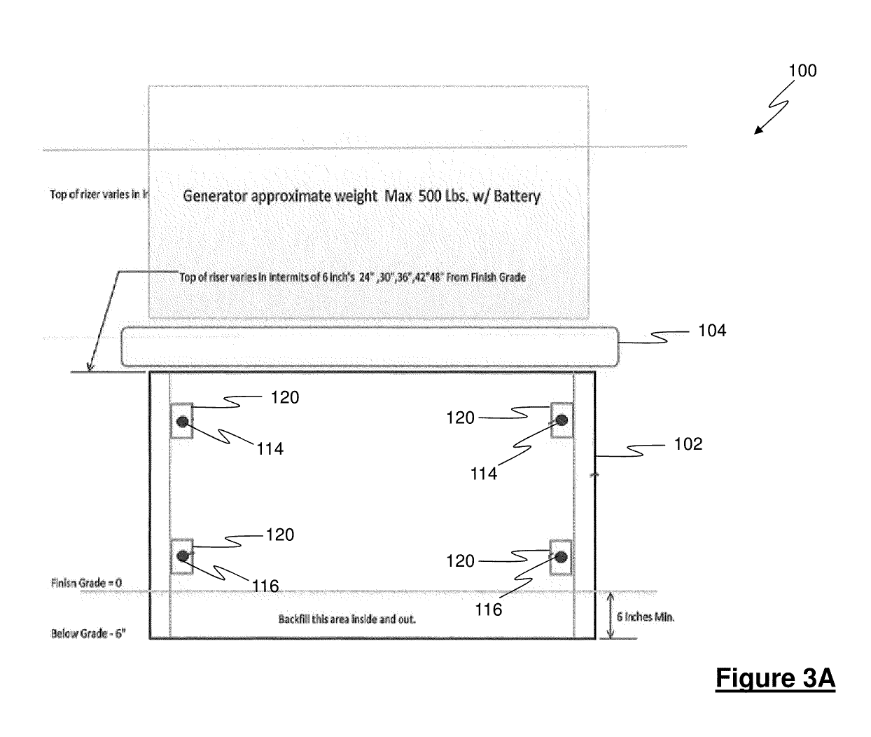

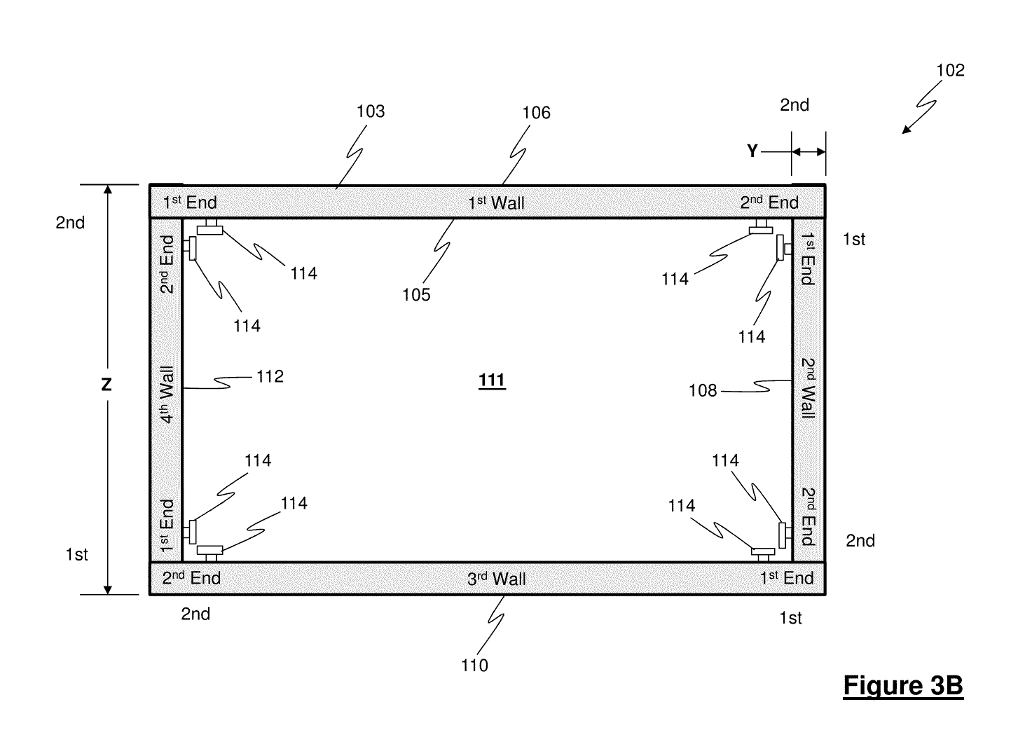

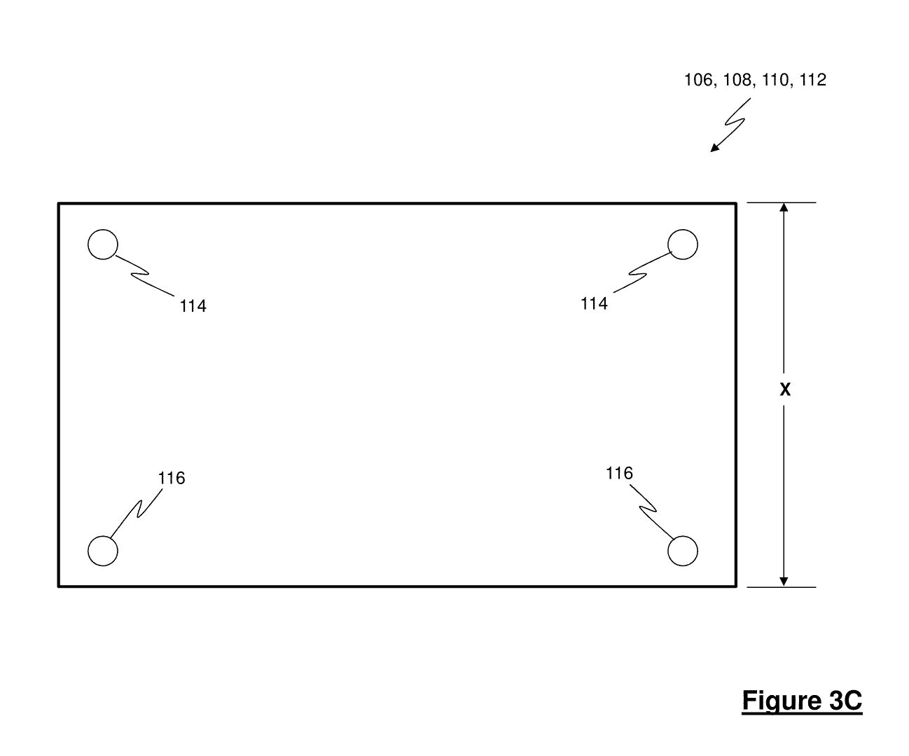

Referring to FIG. 3A, FIG. 3B and FIG. 3C, the support system 100 is shown, wherein the precast concrete riser 102 includes a first wall section 106, a second wall section 108, a third wall section 110 and a fourth wall section 112. Each of the wall sections 106, 108, 110, 112 include a riser front surface 103, a riser rear surface 105, two upper mounting articles 114 and two lower mounting articles 116, wherein one upper mounting article 114 is located on one side of the wall section 106, 108, 110, 112 to be proximate to the top of the wall section 106, 108, 110, 112 and the other upper mounting article 114 is located on the other side of the wall section 106, 108, 110, 112 to be proximate to the top of the wall section 106, 108, 110, 112. Additionally, one lower mounting article 116 is located on one side of the wall section 106, 108, 110, 112 to be proximate to the bottom of the wall section 106, 108, 110, 112 and the other lower mounting article 116 is located on the other side of the wall section 106, 108, 110, 112 to be proximate to the bottom of the wall section 106, 108, 110, 112. One embodiment of this arrangement is illustrated in FIG. 3C. It should be appreciated that the lower and upper mounting articles 116, 114 are located on the wall section 106, 108, 110, 112 such that when one wall section 106, 108, 110, 112 is located adjacent another wall section 106, 108, 110, 112, the upper and lower mounting articles 114, 116 of one wall section 106, 108, 110, 112 are adjacent to the upper and lower mounting articles 114, 116 (respectively) of the adjacent wall section 106, 108, 110, 112.

Moreover, it is contemplated that the mounting articles 114, 116 are securingly associated with the wall sections 106, 108, 110, 112, in a removable and/or non-removable fashion. It should be appreciated that each of the wall sections 106, 108, 110, 112 include a wall height X, a wall width Y and a wall length Z, wherein the wall height X, the wall width Y, and/or the wall length Z may be of varying sizes based upon the particular application. For example, wetter areas may require a higher wall height X than dryer areas. Also, a wall section 106, 108, 110, 112 that has to support a heavy generator may require a wall width Y that is larger (to support greater weight) than a wall section 106, 108, 110, 112 that has to support a lighter generator. For example, in one embodiment, the wall width Y may range from about ¼ inch to about 8 inches, and/or the wall height X may range from about 12 inches to about 60 inches, and/or the wall length Z may range from about 12 inches to about 120 inches. It should be appreciated that the wall height X, wall width Y and/or wall length Z, may be any size desired suitable to the desired end purpose. Moreover, it should be appreciated that the wall sections 106, 108, 110, 112 may be constructed from any material suitable to the desired end purpose, such as concrete, light-weight concrete, plastic, composite, wood and/or any combination thereof. Additionally, while the wall sections 106, 108, 110, 112 are disclosed herein as being substantially rectangular in shape, the wall sections 106, 108, 110, 112 may be any shape desired suitable to the desired end purpose.

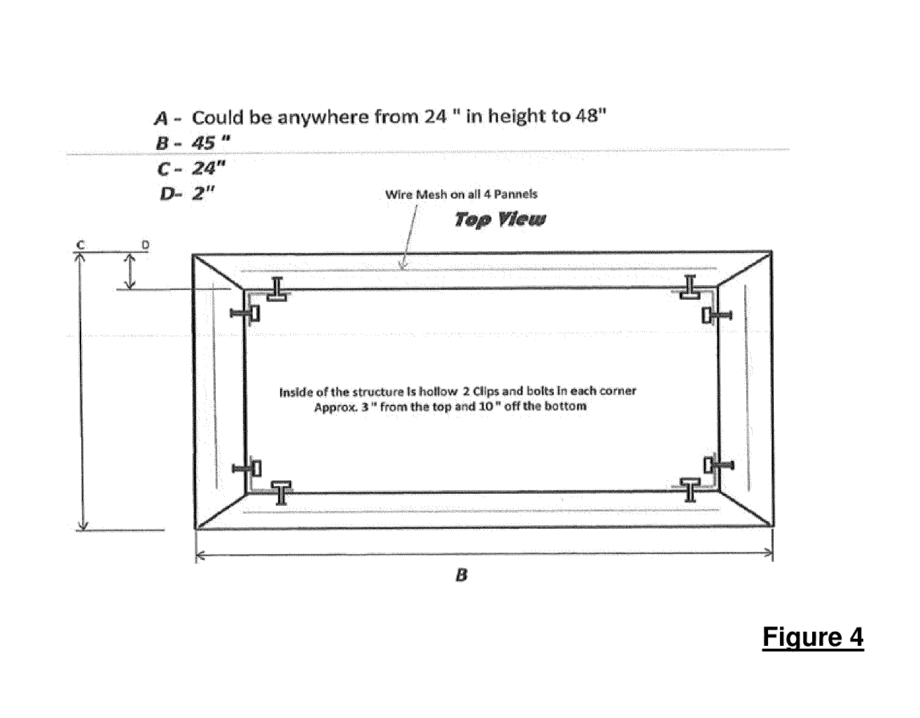

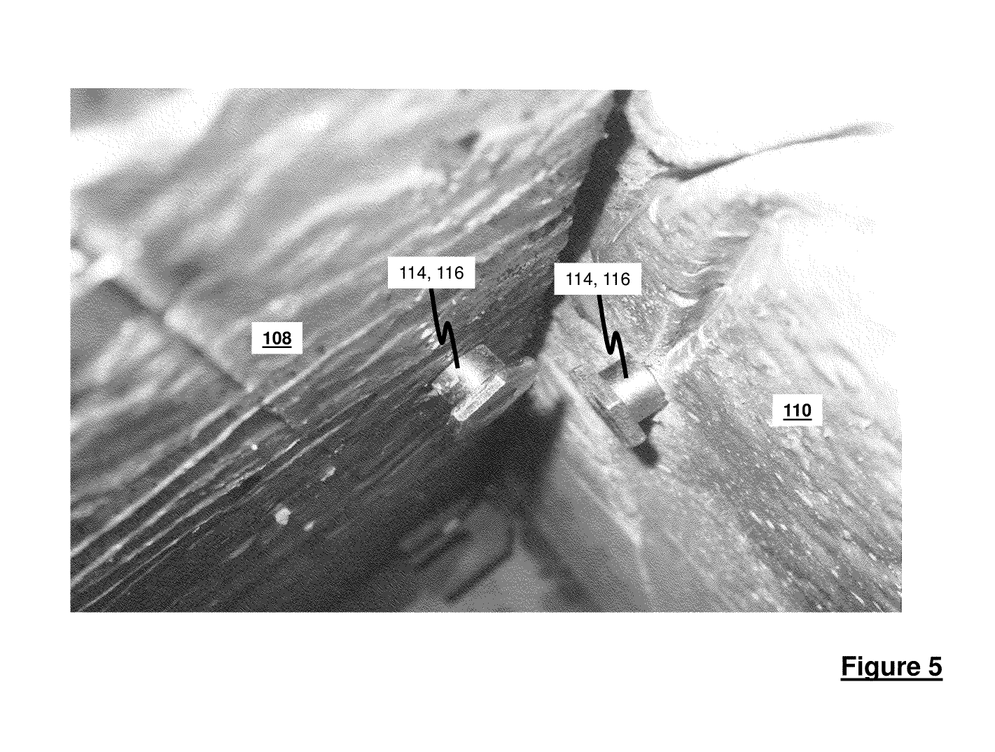

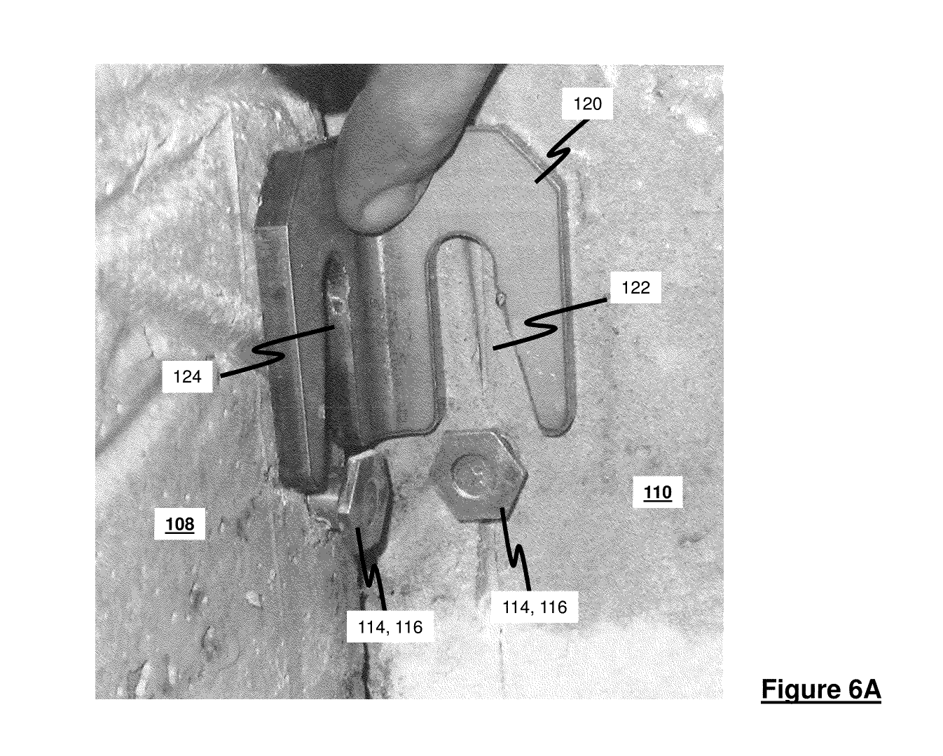

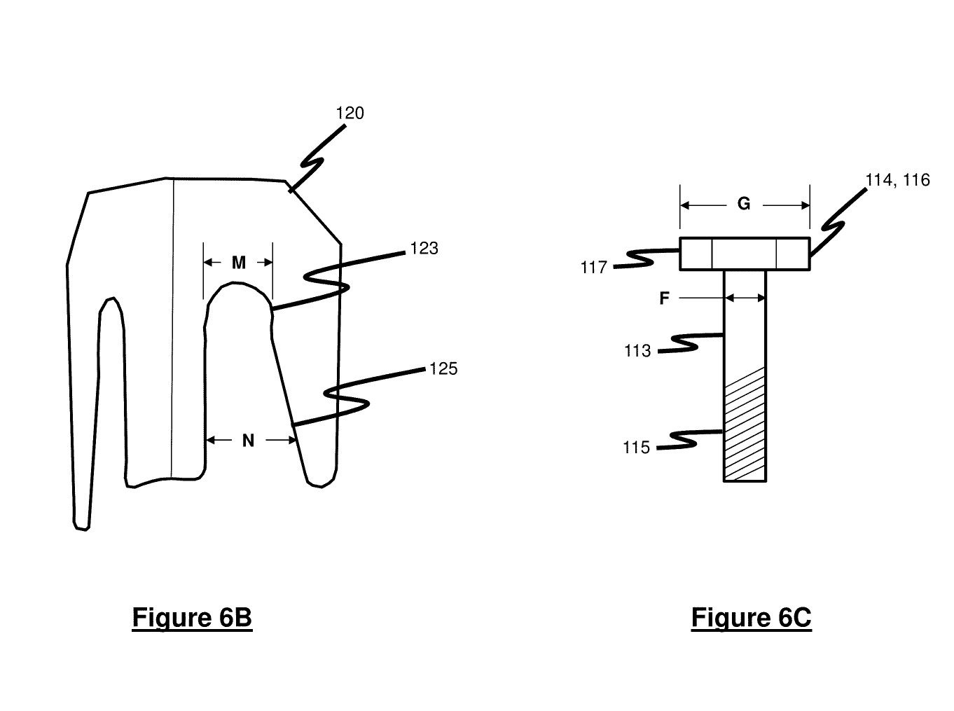

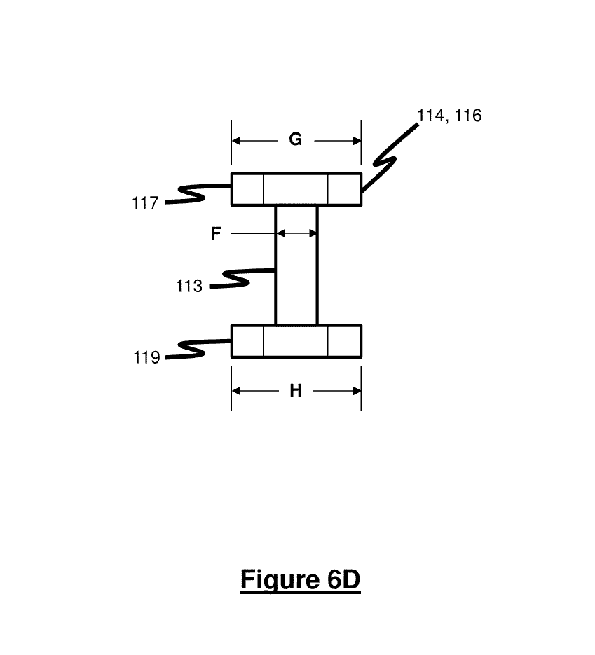

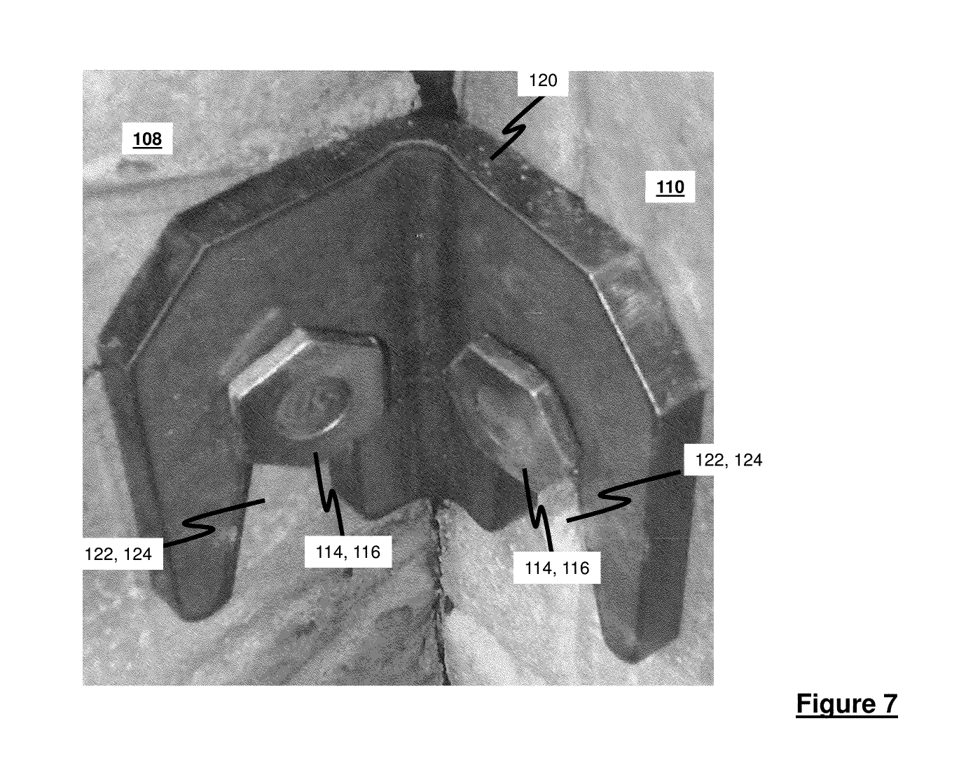

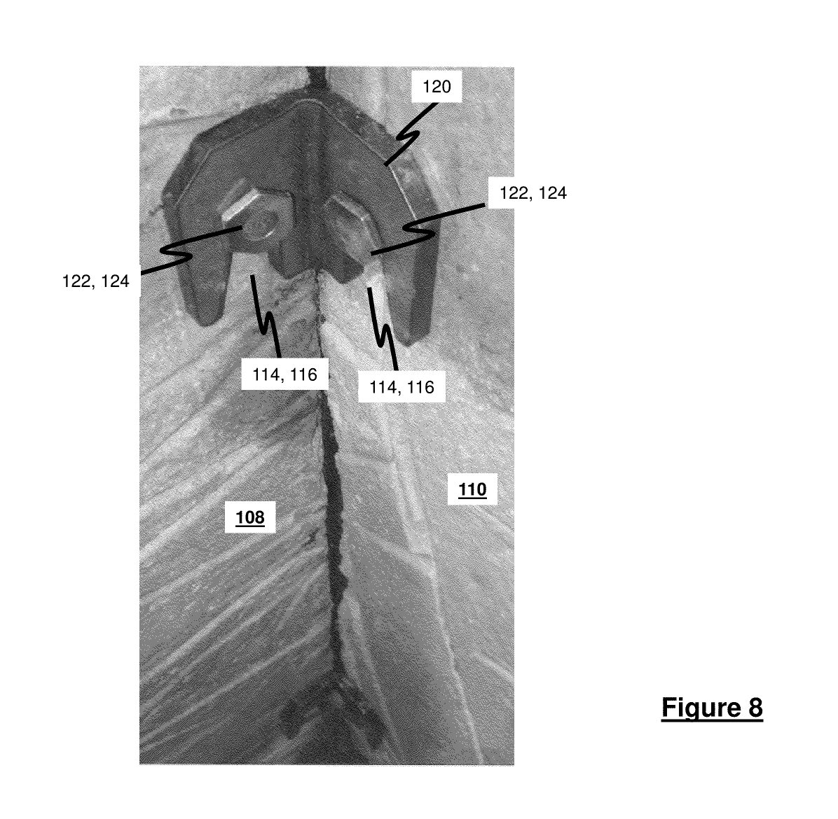

Referring to FIG. 4, FIG. 5, FIG. 6A, FIG. 6B, FIG. 6C, FIG. 6D, FIG. 7 and FIG. 8, the support system 100 also includes a plurality of securing articles 120, wherein each of the securing articles 120 includes a first interface cavity 122 and a second interface cavity 124 and are configured to securingly interact with the mounting articles 114, 116. It should be appreciated that, although the securing article 120 is shown as having an approximately 90 degree angle between the first interface cavity 122 and second interface cavity 124, any angle may exist (such as an acute and/or obtuse angle) between the first interface cavity 122 and second interface cavity 124. This would advantageously accommodate support systems 100 and/or precast concrete risers 102 having a different shape than a rectangular shape. For example, the securing article 120 may be configurable, such as via a hinging member, such that the angle between the first interface cavity 122 and the second interface cavity 124 may be configured to have any angle as desired. In still yet another embodiment, it is contemplated that the wall sections 106, 108, 110, 112 may be secured together other than by use of securing article 120, such as via clips, screws, snaps, etc. It should be appreciated that in one embodiment the first interface cavity 122 and the second interface cavity 124 of the securing article 120 includes a mounting article seating portion 123 having a seating portion width M and a mounting article engaging portion 125 having an engaging portion width N, wherein the engaging portion width N is larger than the seating portion width M. The securing article 120 is associated with the mounting articles 114, 116 by sliding the securing articles 120 over the mounting articles 114, 116 such that the mounting articles 114, 116 are located within the first interface cavity 122 and the second interface cavity 124.

It should be appreciated that in one embodiment, the mounting articles 114, 116 include an article head 117 having a head width G and an article shaft 113 having a shaft width F, wherein the article shaft includes a threaded portion 115. The mounting articles 114, 116 are configured to associate with the securing articles 120, wherein the shaft width F is sized to fit within the mounting article seating portion 123 and wherein the head width G is larger than the seating porting width M. Thus, the securing article 120 is securely associated with the mounting articles 114, 116, such that the mounting articles 114, 116 are seated (i.e. contained) within the mounting article seating portion 123 This configuration prevents the securing article 120 from sliding off of the mounting articles 114, 116. It should be appreciated that in another embodiment, the mounting articles 114, 116 may include an article base 119 having a base width H that is larger than the shaft width F. In this embodiment, the mounting article 114, 116 may be embedded into the concrete such that when the article base 119 is located in the concrete, the concrete is located on flat portions of the article base 119 to help retain the article base 119 within the concrete (See FIG. 6D).

The wall sections 106, 108, 110, 112 of the precast concrete riser 102 are securely associated with each other by locating one wall section 106, 108, 110, 112 on one side of and adjacent to another wall section 106, 108, 110, 112. The upper mounting article 114 of one wall section 106, 108, 110, 112 is then associated with the first interface cavity 122 of a securing article 120 and the upper mounting article 114 of the adjacent wall section 106, 108, 110, 112 is associated with the second interface cavity 124 of the securing article 120 (See FIG. 7 and FIG. 8). Additionally, the lower mounting article 116 of one wall section 106, 108, 110, 112 is associated with the first interface cavity 122 of a securing article 120 and the lower mounting article 116 of the adjacent wall section 106, 108, 110, 112 is associated with the second interface cavity 124 of the securing article 120. This is repeated until each side of each wall section 106, 108, 110, 112 is associated with an adjacent wall section 106, 108, 110, 112. It should be appreciated that in this way the precast concrete riser 102 defines a riser cavity 111 which is defined by the wall sections 106, 108, 110, 112. An article support pad 104 is located on top of the precast concrete riser 102 to act as a platform for a generator (or other article). It should be appreciated that the generator pad may be secured to the riser via any method suitable to the desired end purpose, such as via a clip, snap, screw, liquid adhesive.

It should be appreciated that in one embodiment, the precast concrete riser 102 may be located within soil by excavating approximately 6 inches from the final grade, placing the precast concrete riser 102 within the excavated area and backfilling both inside and outside the completed riser up to an approximate 6 inch depth. However, it is contemplated that the precast concrete riser 102 may also be located on any stable, secure surface.

Referring again to FIG. 1 and FIG. 2, it should be appreciated that the wall section 106, 108, 110, 112 may be cast so that, when they are assembled, the precast concrete riser 102 will have the appearance of being constructed out of concrete blocks that have been mortared together (or other design if desired).

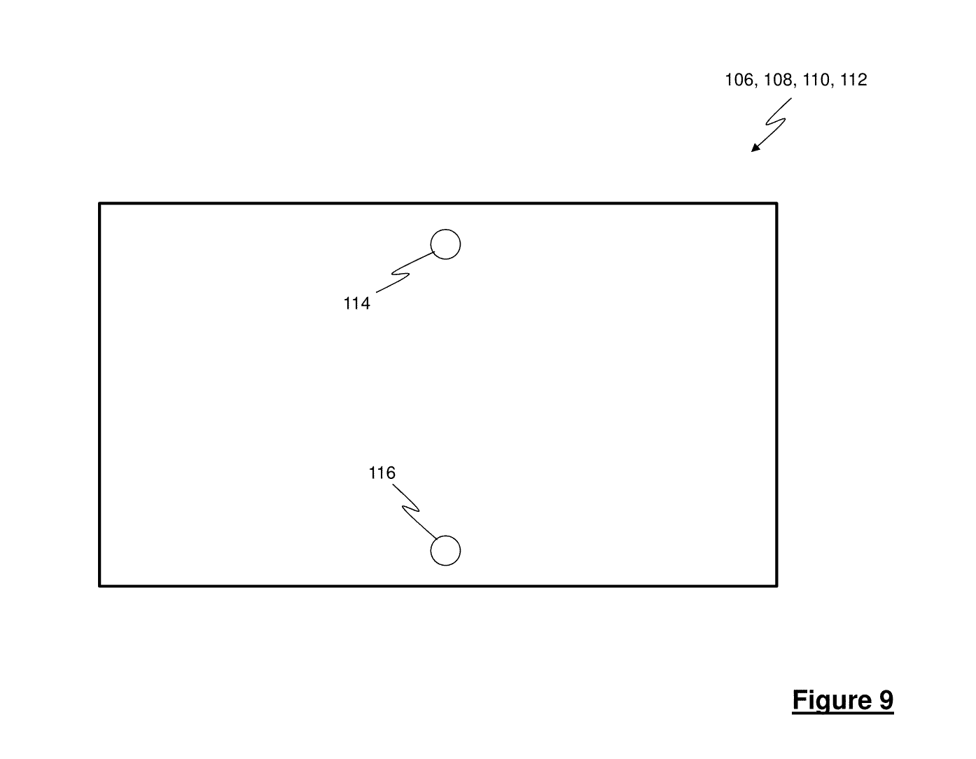

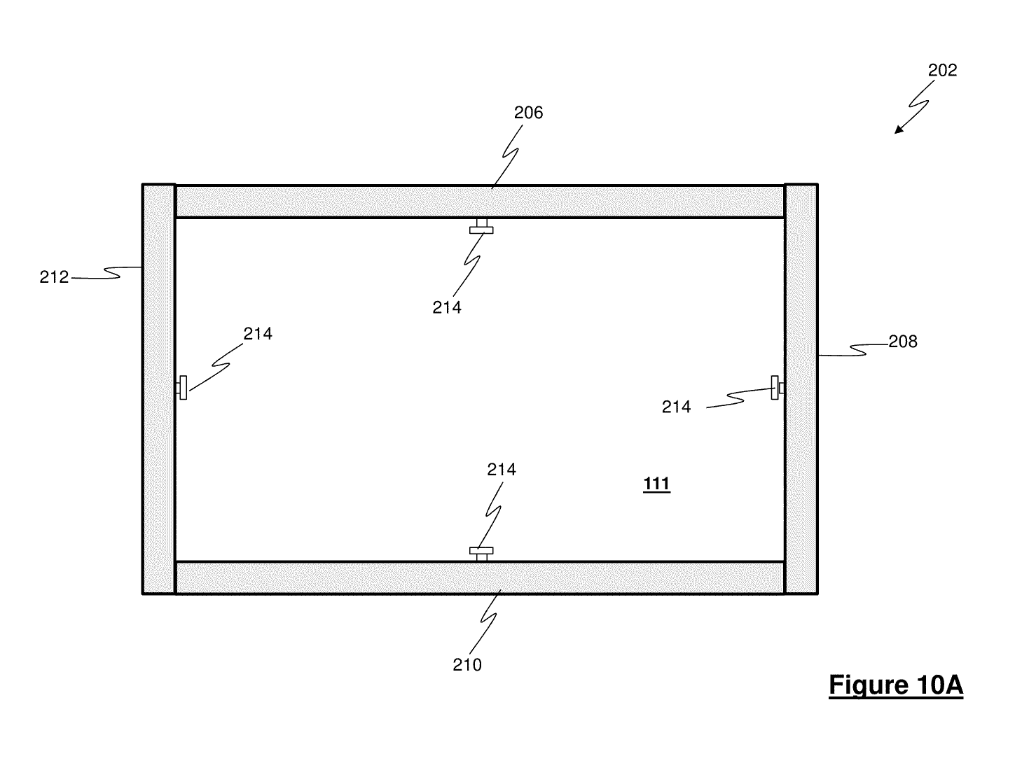

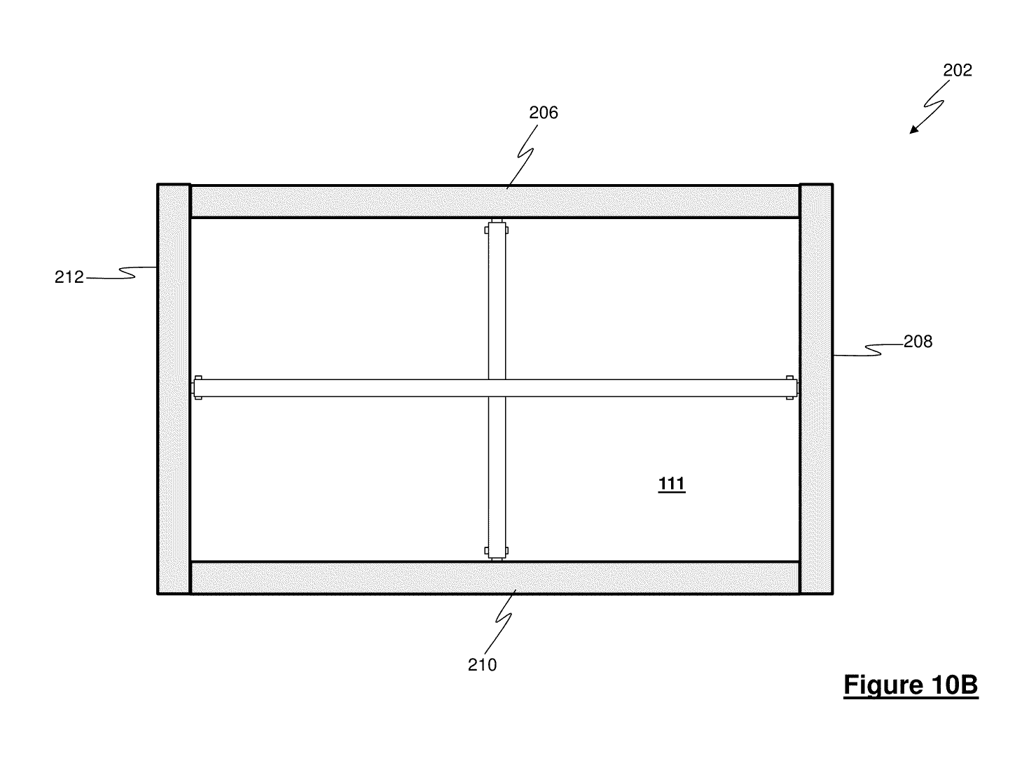

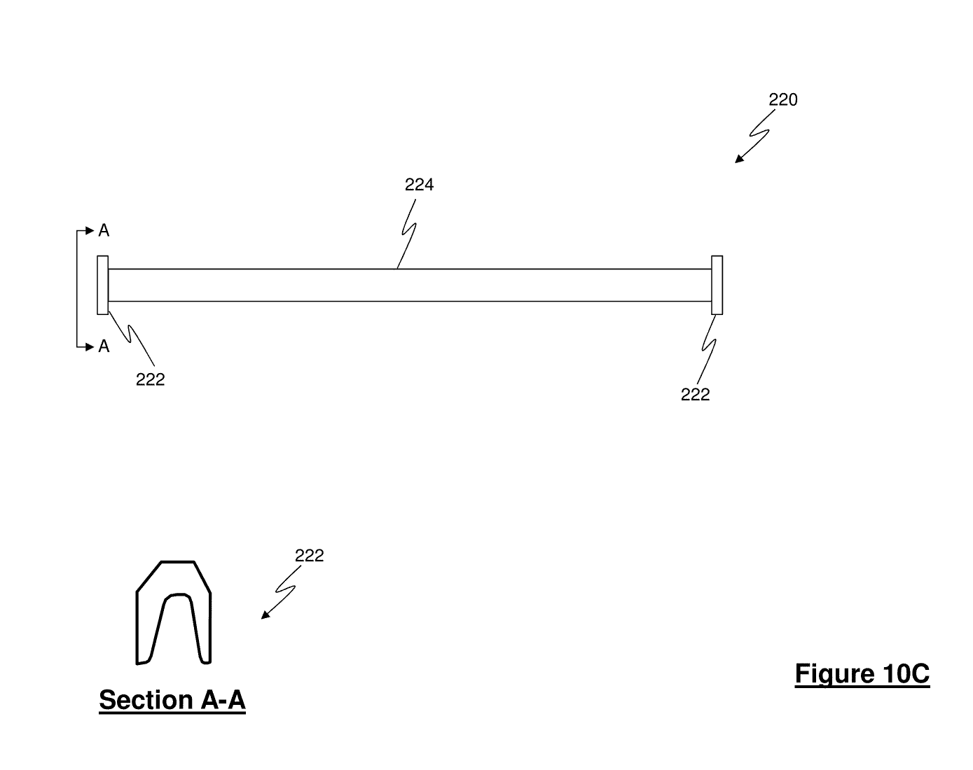

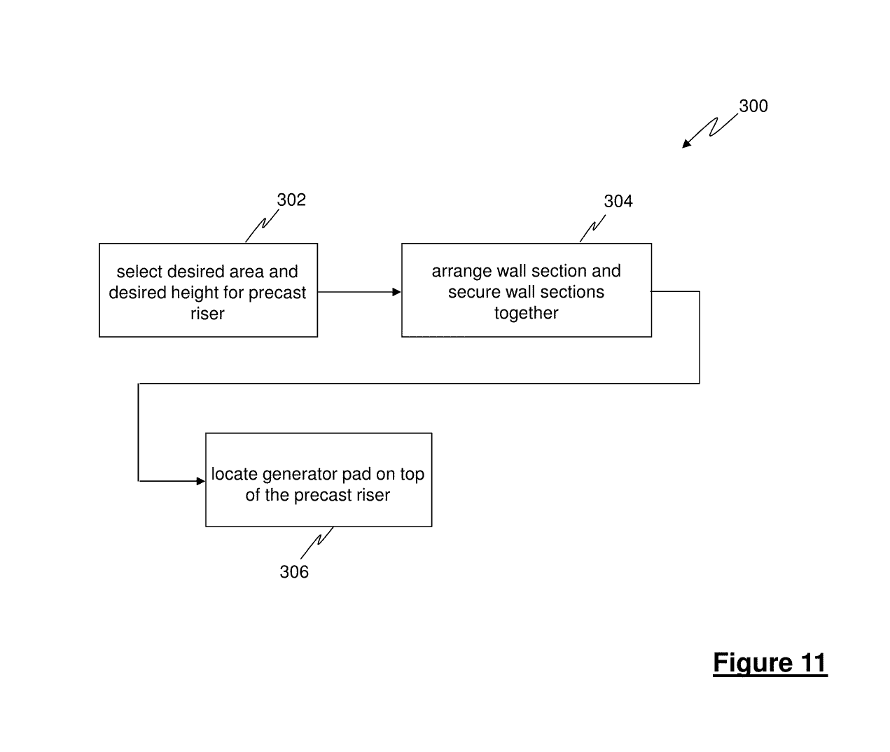

Referring to FIG. 9, FIG. 10A, FIG. 10B and FIG. 10C, another embodiment of a precast concrete riser 202 is shown and includes wall sections 206, 208, 210, 212 where each of the wall sections 206, 208, 210, 212 includes one mounting article 214, where the wall sections 206, 208, 210, 212 of the precast concrete riser 202 are securely connected to an opposing wall section 206, 208, 210, 212. This may be accomplished in a manner similar to the previous embodiment(s), with the difference being that the securing articles 220 includes end brackets 222 attached via a rigid bracket bar 224. In still yet another embodiment, it is contemplated that bracket bar 224 may be used in combination with the mounting articles 114, 116 and the securing article 120.

Referring again to the figures, the present invention may be assembled using four precast concrete wall sections 106, 108, 110, 112 that are approximately 2 inches thick (although any thickness suitable to the desired end purpose may be used) and that may or not be reinforced. In the preferred embodiment, the four precast concrete wall sections 106, 108, 110, 112 may be reinforced with #5 epoxy coated rebar installed two per precast concrete wall section—one near the top and one near the bottom—but may also be reinforced with welded wire mesh (or other material). In the preferred embodiment, the precast concrete wall sections 106, 110 may be 45 inches in length and the precast concrete wall sections 108, 112 may be 24 inches in length. The height of the precast concrete wall sections 106, 108, 110, 112 may vary in height depending upon the application.

Referring to figures, in one embodiment, the support system 100 may generally be assembled by one end of a first wall section 106 being placed adjacent and perpendicular to one end of a second wall section 108 and securely associating the first and second wall sections 106, 108 together using the mounting articles 120 as discussed and shown herein. One end of a third wall section 110 is placed adjacent and perpendicular to the other end of the first wall section 106 and securely associating the first and third section 106, 110 wall sections together using the mounting articles 120 as discussed and shown herein. A fourth wall section 112 is then placed adjacent and perpendicular to the other ends of the second and third wall sections 108, 110 and the fourth wall section 112 is securely associated with the second and third wall sections 108, 110 together using the mounting articles 120 as discussed and shown herein.

It should be appreciated that the precast concrete riser 102, 202 may be prefabricated in various sizes that can be quickly and efficiently installed as part of any standby generator package at any location to provide protection from hazards that affect generators installed at ground level. Thus, the invention can be used as part of the process of supporting a standby generator above grade level in order to provide moisture isolation and/or protection.

Referring to FIG. 11, a method 300 for assembling a precast concrete riser 102, 202 is provided, wherein the method 300 may be used to locate a generator above grade level for moisture protection/isolation. The method 300 includes selecting a desired area to locate the precast concrete riser 102, 202 and determining a desired height of the precast concrete riser 102, 202 as shown in operational block 302. The wall sections 106, 108, 110, 112, 206, 208, 210, 212 are arranged and secured together as discussed herein above, as shown in operational block 304. It should be appreciated that, in some instances as desired, the area may be excavated to a predetermined depth (for example approximately 6 (six) inches below finished grade level) so that the precast concrete riser 102, 202 can have a foundation within the soil. In this case, once the precast concrete riser 102, 202 is assembled, the excavated area (outside and inside the assembled precast concrete riser) may be backfilled with a suitable material, such as dirt, stone, etc. The article support pad 104, which may or may not be precast concrete, is then placed on top of the precast concrete riser 102, 202, where the article support pad 104 may or may not be secured to the precast concrete riser 102, 202, as shown in operational block 306.

It should be appreciated that the wall sections 106, 108, 110, 112, 206, 208, 210, 212 and/or the article support pad 104 may be constructed from any material suitable to the desired end purpose, such as concrete, and may or may not be reinforced as desired. It is also contemplated that the riser 102, 202 may be any shape as desired, such as rectangular (including square), triangular, semi-circular, octagonal, hexagonal, etc. Moreover, it is contemplated that the mounting articles may be permanently attached the wall sections 106, 108, 110, 112, 206, 208, 210, 212 and/or they may be removably securable to the wall sections 106, 108, 110, 112, 206, 208, 210, 212 via a clip, hinge, screw, etc.

In a preferred embodiment, wall sections 106, 108, 110, 112 are manufactured out of precast concrete. The standard method of manufacturing any product out of precast concrete requires the construction of forms; the installation of rebar or other steel reinforcement; the pouring of the concrete into the forms; and the stripping of forms. Such an operation typically requires several workers and heavy equipment. The present invention includes a method by which the wall sections 106, 108, 110, and 112 may be manufactured from precast concrete by a single worker without the need for heavy equipment by using an apparatus specifically manufactured for that purpose.

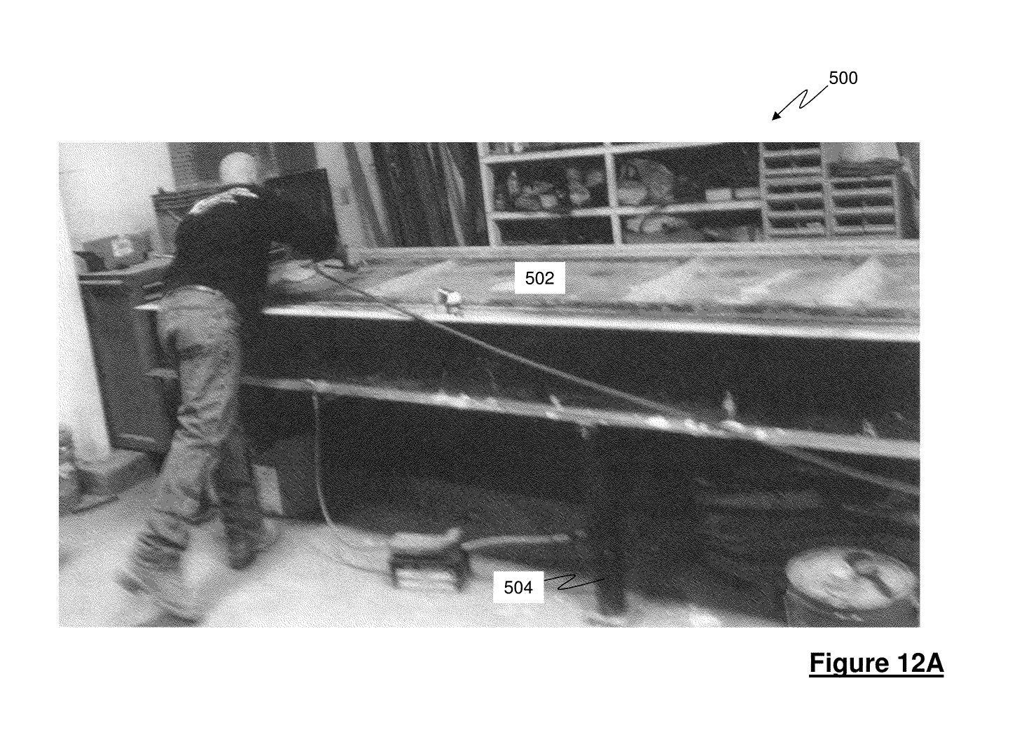

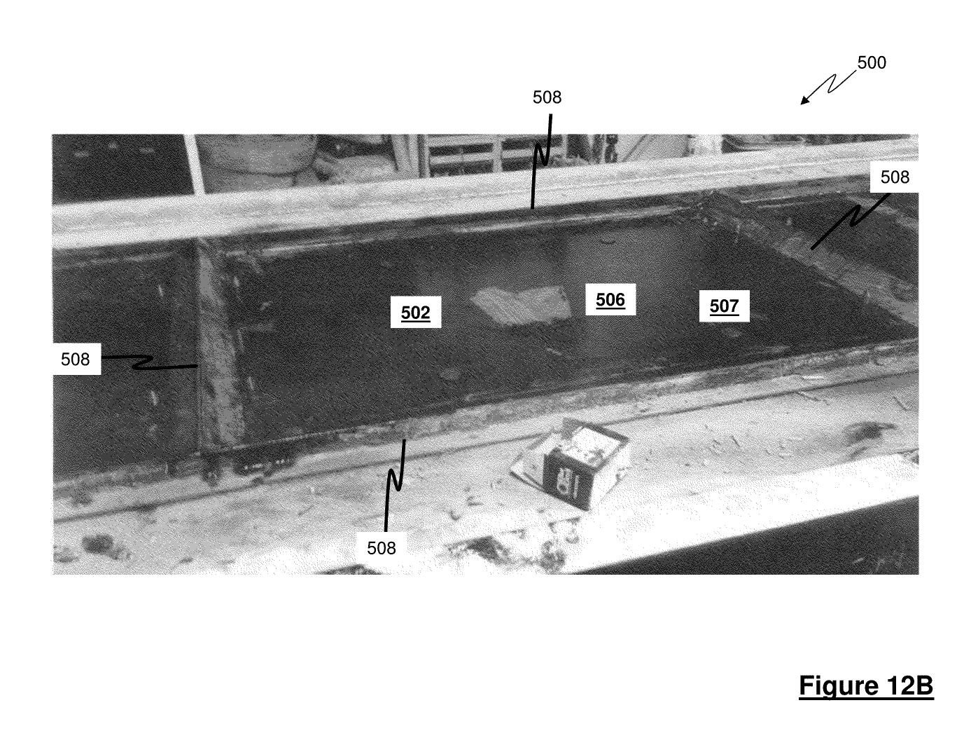

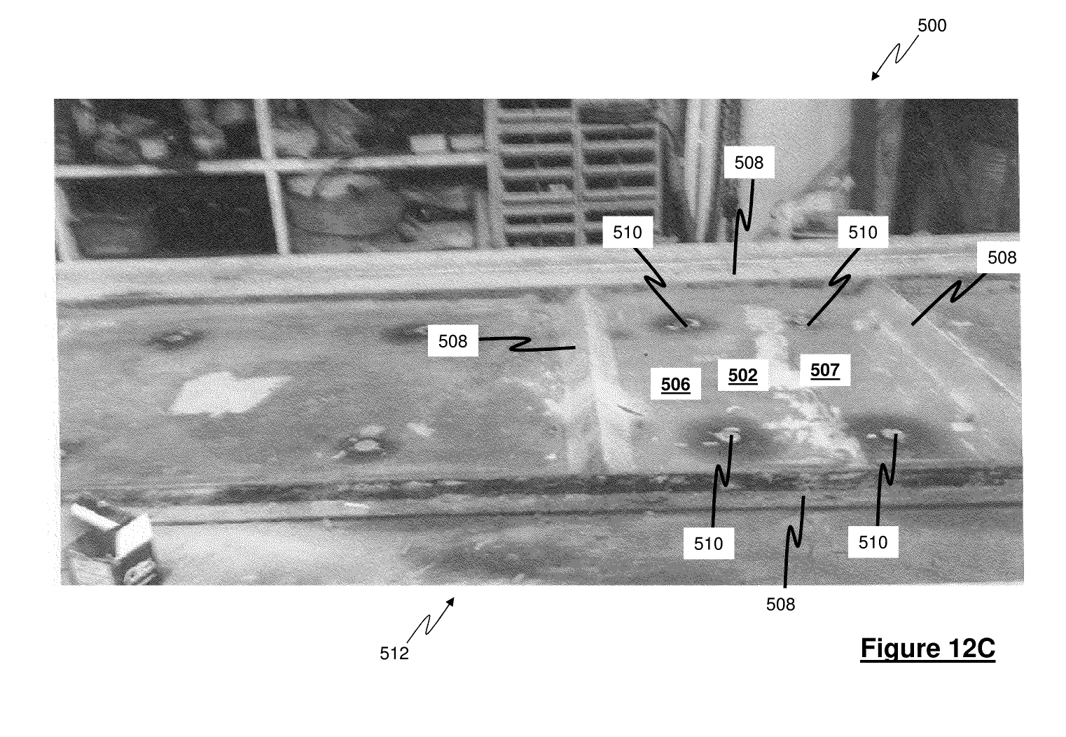

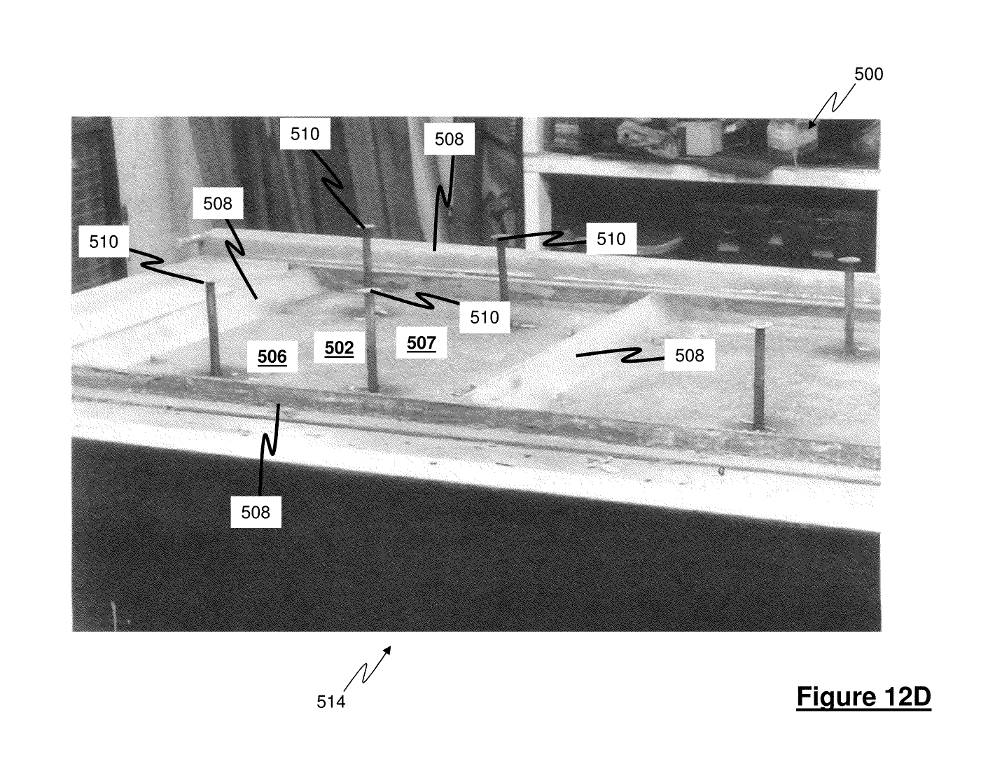

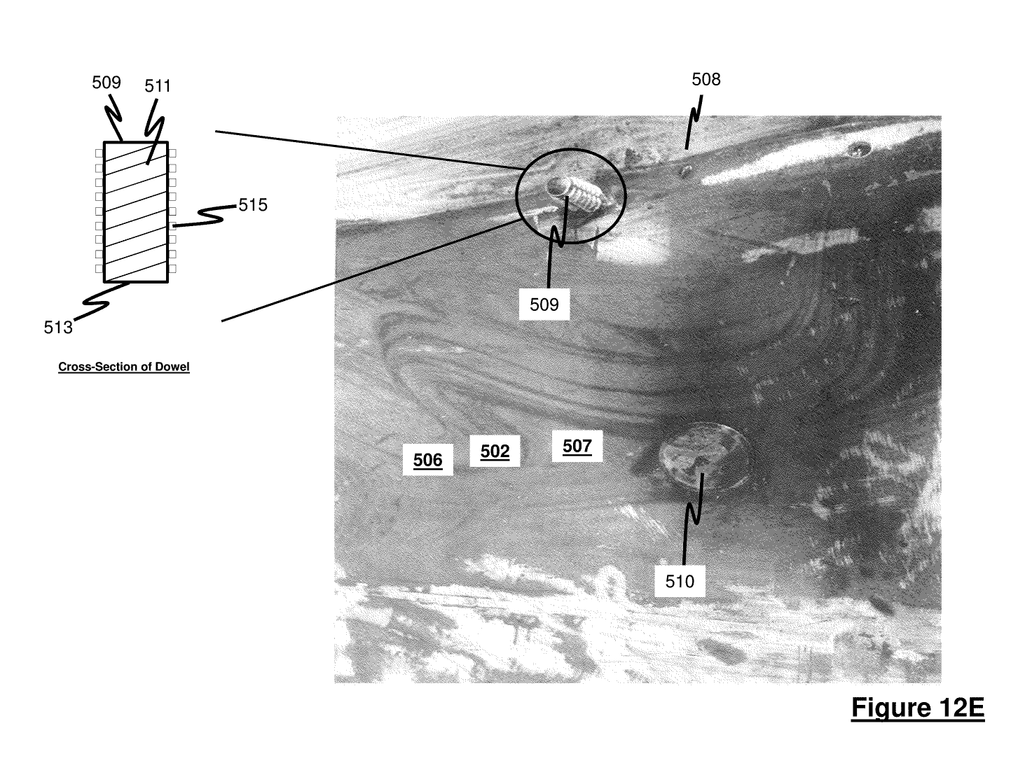

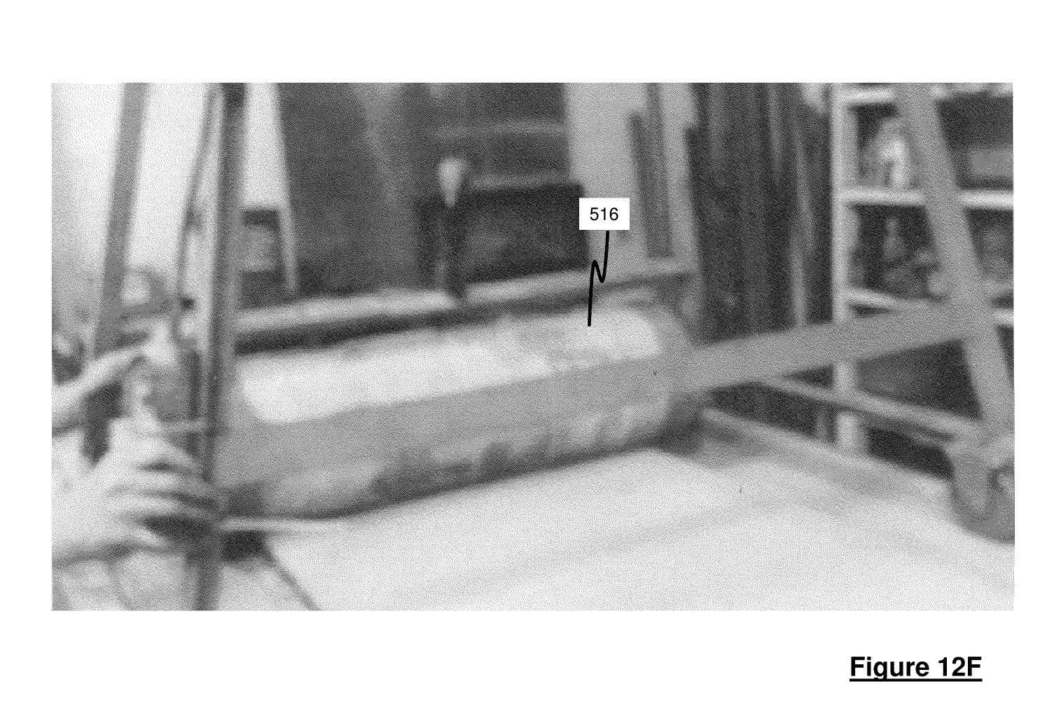

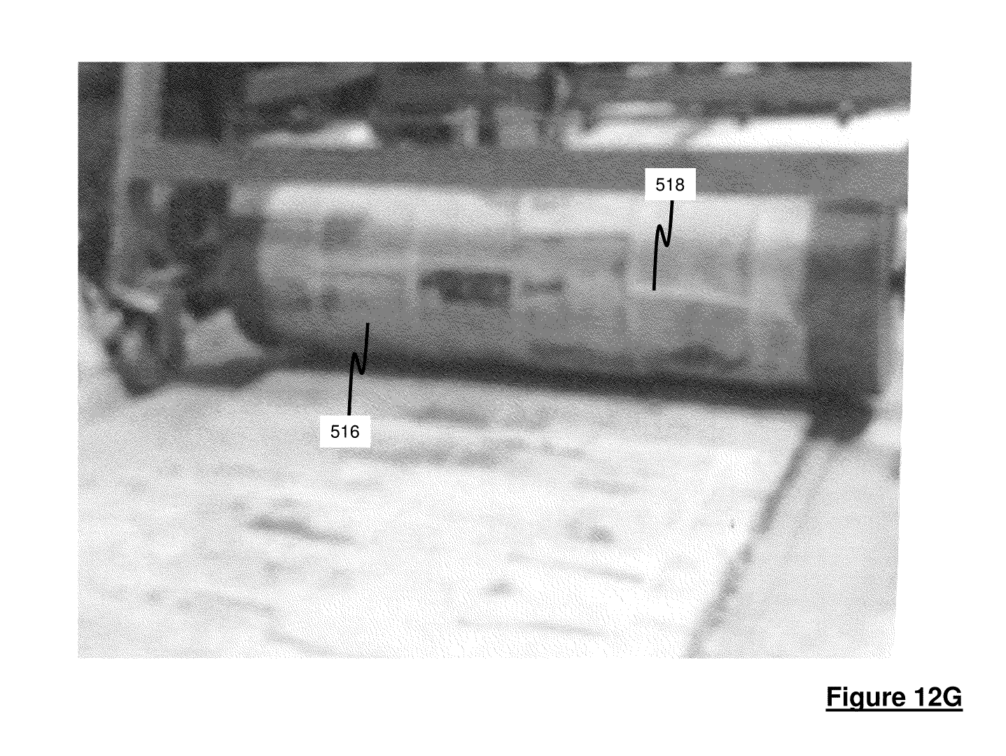

Referring to FIG. 12A FIG. 12E, a fabrication platform 500 for fabricating the wall sections 106, 108, 110, 112 is provided and includes a platform top 502 and a platform support 504, in accordance with one embodiment of the invention. The platform top 502 includes at least one forming cavity 506, a plurality of edge walls 508 and at least one displacing article 510, wherein the forming cavity 506 is defined by a cavity surface 507 and a plurality of edge walls 508, and the at least one displacing article 510 is at least partially located within the forming cavity 506 and movably associated with the platform top 502 to be configurable between a first configuration 512 and a second configuration 514. Moreover, the plurality of concrete walls may include a threaded cavity. This may be accomplished via dowels 509, wherein the cavity surface 507 includes a plurality of dowel pins that protrude upward from the cavity surface 507 to identify the location of the mounting articles 114, 116. The dowels 509, having a dowel threaded inner cavity 511 and a dowel opening 513 communicated with the dowel threaded inner cavity 511, are located on the dowel pins such that when forming cavity 506 is filled with concrete and the concrete is cured, the dowels 509 are located within the concrete and the dowel opening 513 is accessible from the rear of the wall sections 106, 108, 110, 112 to allow access to the dowel threaded inner cavity 511. It should be appreciated that the dowels 509 include protrusions 515 (or depressions) on its outer surface to provide horizontal surfaces for the concrete to adhere to in order to more securely associate the dowel 509 with the wall sections 106, 108, 110, 112. This configuration advantageously allows the mounting articles 114, 116 to securely associate with the dowels 509 by screwing the mounting articles 114, 116 to the dowels 509 via the dowel threaded inner cavity 511. Additionally, as discuss further hereinafter, the platform 500 includes a forming member 516 which is configured to roll (or move) along the top of the edge walls 508, wherein the forming member 516 may include protrusions (or depressions) 518 on its surface that are arranged to create designs in the surface of the wall sections 106, 108, 110, 112. As the forming member 516 moves along, it creates a pattern in the surface of the concrete. It should be appreciated that a platform 500 having a plurality of forming cavities 506 is contemplated and allows for multiple wall sections 106, 108, 110, 112 to be fabricated simultaneously.

In accordance with one embodiment of the invention, a method 600 for fabricating a wall section 106, 108, 110, 112 using the fabrication platform 500 is discussed as follows. Referring again to FIG. 12A, the at least one forming cavity 506 is cleaned to remove any debris located on the surfaces within the at least one forming cavity 506, as shown in operational block 602. This may be accomplished via any method and/or device suitable to the desired end purpose, such as using compressed air to blow (i.e. remove) particulate from the at least one forming cavity 506.

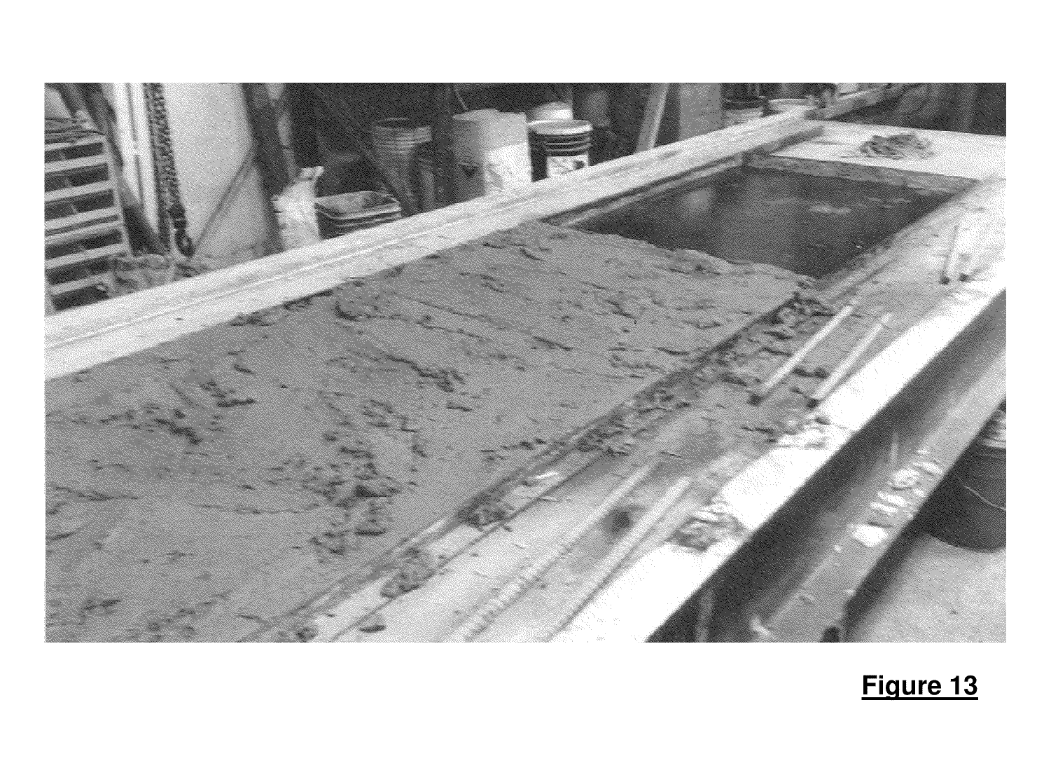

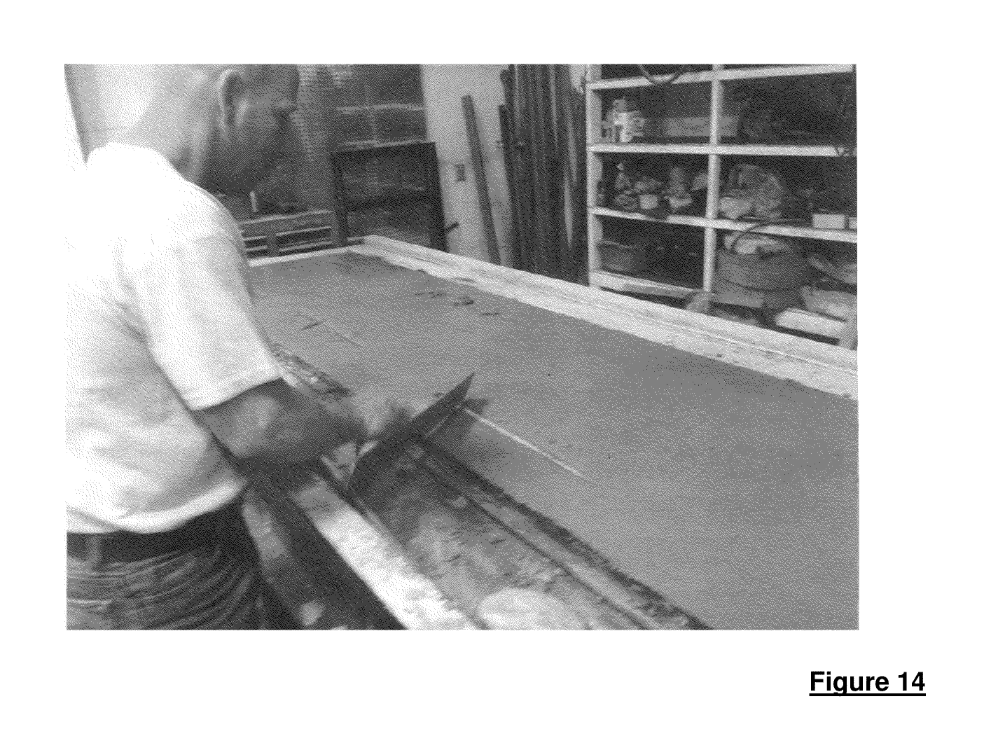

Referring again to FIG. 12B, the surface of the at least one forming cavity 506 is coated with a release agent, as shown in operational block 604. It should be appreciated that any release agent that would prevent (or limit) damage to the concrete wall sections 106, 108, 110, 112 when removed from the forming cavity 506 and suitable to the desired end purpose may be used, such as Harris Super X VOC AIM. The dowels 509 are located over the dowel pins, as shown in operational block 606. Referring to FIG. 13, a concrete material is then placed within the forming cavity 506 and spread to a substantially uniform thickness throughout the forming cavity 506 to be substantially level with the top of the edge walls 508, as shown in operational block 608. The concrete material is then smoothed to create a substantially flat surface. It should be appreciated that any concrete (or concrete type) having a load strength and durability may be used suitable to the desired end purpose may be used. For example, in one embodiment, the concrete is a 5000 PSI grout mixture. Referring to FIG. 14, reinforcing material (such as epoxy coated “#5 rebar”) may be located within the concrete in the forming cavity 506 to be completely covered by the concrete, as shown in operational block 610. In one embodiment, epoxy coated #5 reinforcing bars of metal (“rebar”) are located within the concrete where two lengths of rebar may be used for each wall section 106, 108, 110, 112, one located on one end of the wall section 106, 108, 110, 112 and one located on the other end of the wall section 106, 108, 110, 112. It is contemplated that other methods and/or devices may be used to reinforce the wall section 106, 108, 110, 112 as desired. For example, in one embodiment, the wall section 106, 108, 110, 112 may be reinforced through the use of welded wire fabric, uncoated rebar and/or other rebar sizes and/or configurations.

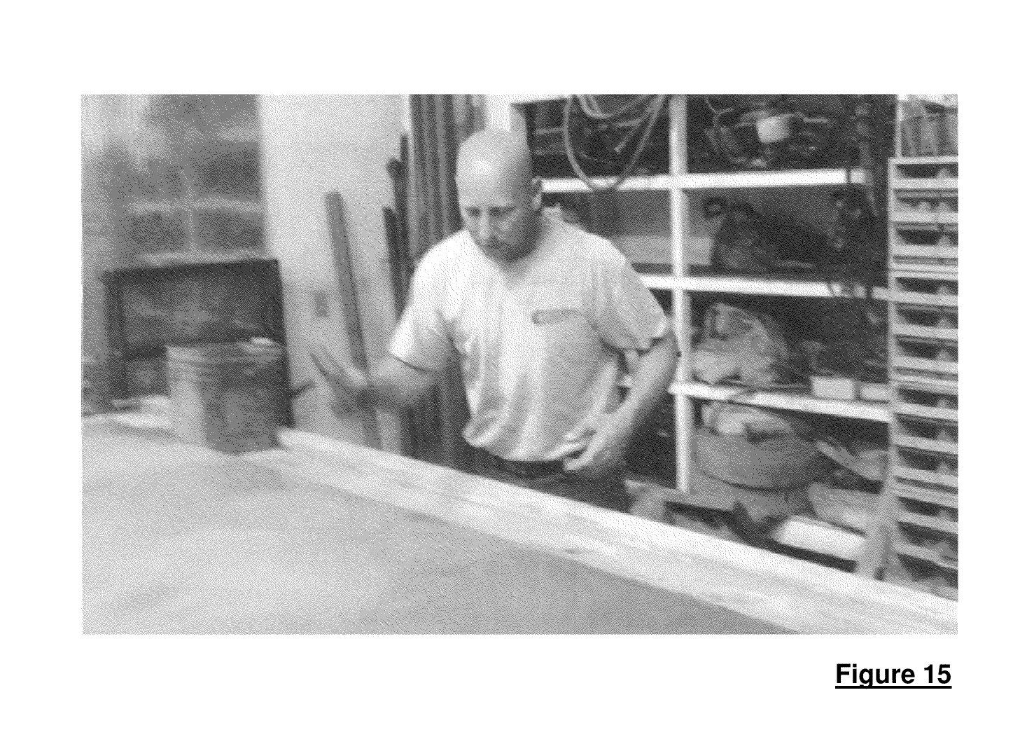

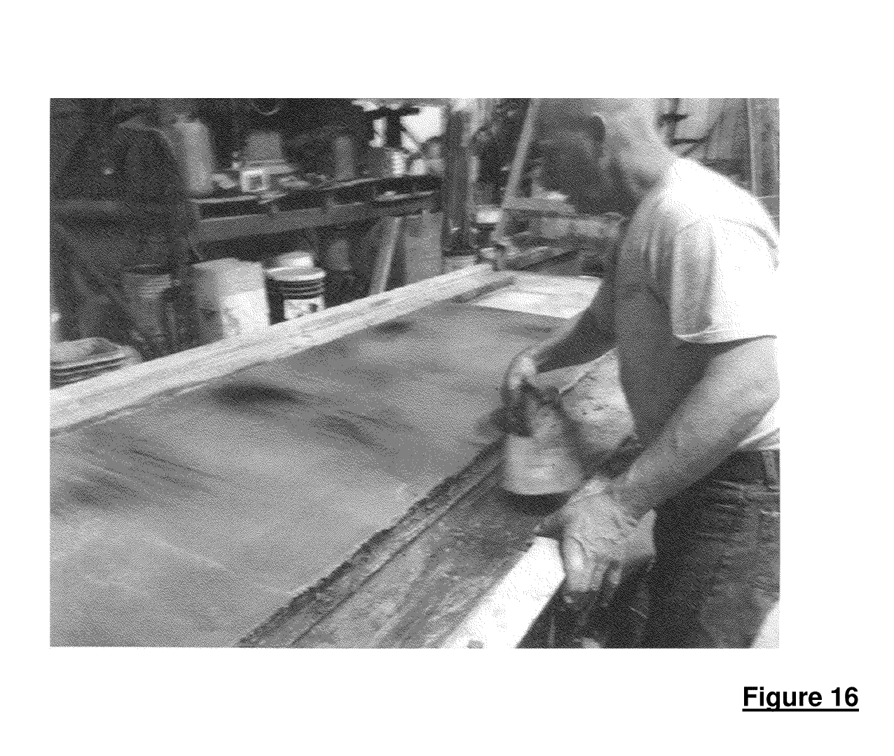

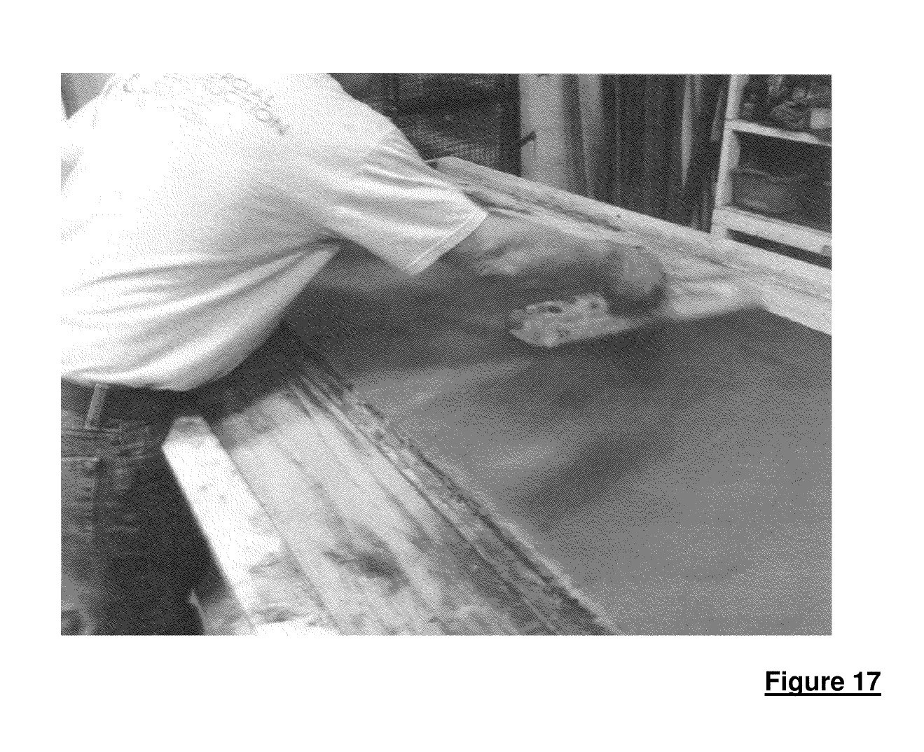

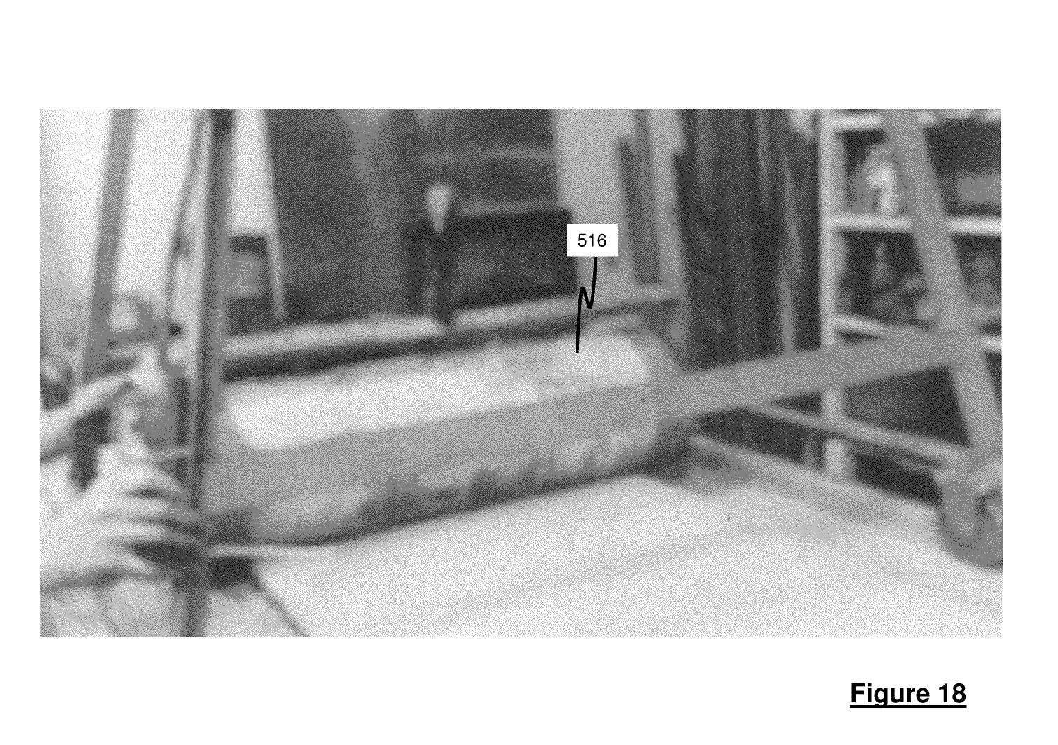

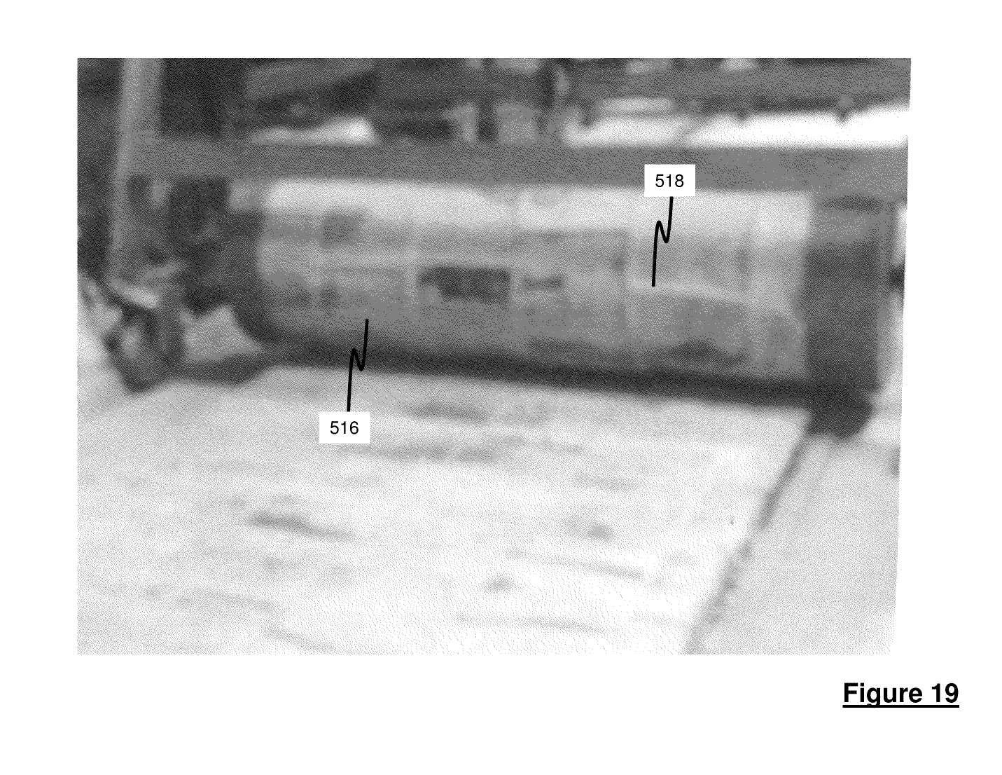

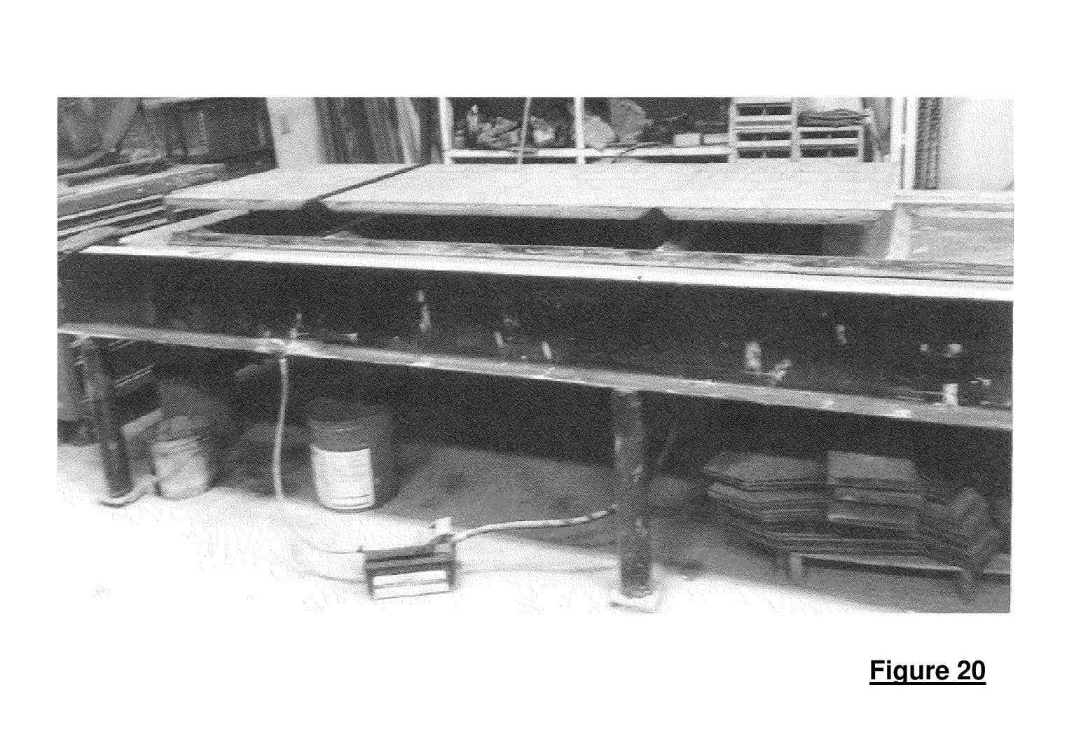

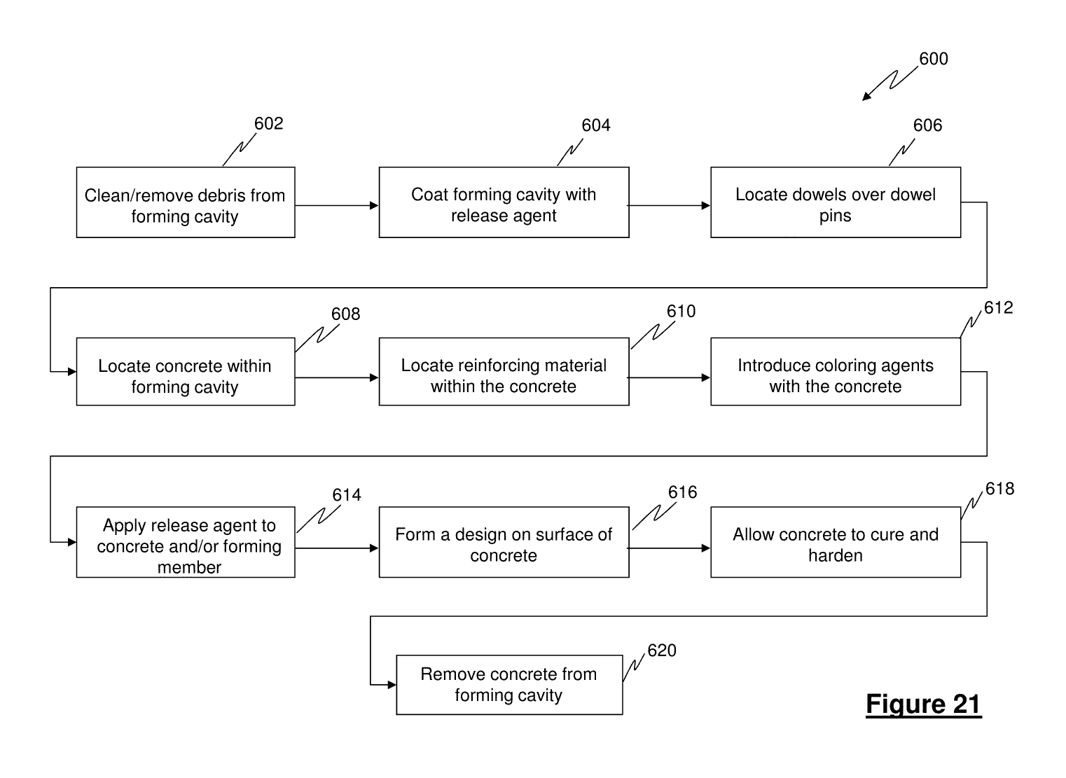

Referring to FIG. 15-17, coloring agents may be introduced to the concrete located within the forming cavity 506, as shown in operational block 612. In one embodiment, this may be accomplished by applying a coloring agent to the surface of the concrete, wherein the concrete may then be “floated” to smooth the surface of the concrete. It should be appreciated that one or more coloring agents (or combinations of coloring agents) may be used depending upon a desired aesthetic appearance. Additionally, a release agent should be applied to the concrete and/or forming member 516 to prevent the concrete and the forming member 516 from adhering together as shown in operational block 614. Referring to FIG. 18-19, the forming member 516 is rolled along across the surface of the concrete such that the protrusions on the surface of the forming member 516 forms a design in the concrete surface of the concrete located within the forming cavity 506, as shown in operational block 616. The concrete is then allowed to cure, as shown in operational block 618. Referring to FIG. 20, when the concrete has cured, the wall section 106, 108, 110, 112 may be removed from the forming cavity 506, as shown in operational block 620. This may be accomplished by configuring the at least one displacing article 510 between the first configuration 512 and second configuration 514, wherein when in the first configuration 512, the at least one displacing article 510 is located flush with the cavity surface 507 and when in the second configuration 514, the at least one displacing article 510 is protruding upward from the cavity surface 507. As such, when the at least one displacing article 510 is being configured into the second configuration 514, the at least one displacing article 510 pushes upward against the wall section 106, 108, 110, 112 to remove the wall section 106, 108, 110, 112 from the forming cavity 506. The at least one displacing article 510 may be operated by pneumatic, electric, manual means, and/or via a combination of pneumatic, electric, and/or manual means. By way of example but not of limitation, the pneumatic means may be an air compressor, the electric means may be an electric motor, and the manual means may be a hand crank. The removed wall section 106, 108, 110, 112 is then ready for transport and assembly. It should be appreciated that the wall section 106, 108, 110, 112 may be pressure washed and/or sealed if desired.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the description and any appended claims. Moreover, unless specifically stated any use of the terms first, second, etc. do not denote any order or importance, but rather the terms first, second, etc. are used to distinguish one element from another.

I claim:

1. A support riser for supporting a generator, comprising:
a plurality of walls, wherein each of the plurality of walls includes a wall front surface, a wall rear surface, a wall top, a wall bottom, a first end and a second end;
a plurality of securing articles; and
a plurality of mounting articles, wherein the plurality of mounting articles are configured to be securely associated with the wall rear surface of the plurality of walls and wherein the plurality of securing articles are configured to securely associate with the plurality of mounting articles.

2. The support riser of claim 1, wherein each of the plurality of walls includes a plurality of threaded dowel cavities, wherein one threaded cavity is located in each corner of the wall rear surface.

3. The support riser of claim 2, wherein each of the plurality of mounting articles includes an article head and an article shaft, wherein the article shaft includes a threaded portion configured to threadingly engage with the plurality of threaded dowel cavities.

4. The support riser of claim 1, wherein each of the plurality of securing articles includes a first interface surface defining a first interface cavity and a second interface surface defining a second interface cavity.

5. The support riser of claim 4, wherein the first interface surface is substantially perpendicular to the second interface surface.

6. The support riser of claim 4, wherein each of the first interface cavity and the second interface cavity includes a seating portion configured to contain at least a portion of the article shaft.

7. The support riser of claim 4, wherein the plurality of walls includes a first wall, a second wall, a third wall and a fourth wall and wherein,
the second end of the first wall is located proximate to the first end of the second wall such that the first wall is substantially perpendicular to the second wall,
the second end of the second wall is located proximate to the first end of the third wall such that the second wall is substantially perpendicular to the third wall,
the second end of the third wall is located proximate to the first end of the fourth wall such that the third wall is substantially perpendicular to the fourth wall, and
the second end of the fourth wall is located proximate to the first end of the first wall such that the fourth wall is substantially perpendicular to the first wall.

8. The support riser of claim 4, wherein,
the first wall is securely associated with the second and fourth walls via at least one securing article, and
the third wall is securely associated with the second and fourth walls via at least one securing article.

9. The support riser of claim 1, further including an article support pad configured to be associated with the wall top of the first wall, second wall, third wall and fourth wall to be supported by the first wall, second wall, third wall and fourth wall.

10. A precast concrete support riser for supporting a generator, comprising:
a first precast concrete wall,
a second precast concrete wall,
a third precast concrete wall, and
a fourth precast concrete wall, wherein each of the first precast concrete wall, second precast concrete wall, third precast concrete wall and fourth precast concrete wall includes a wall front surface, a wall rear surface, a wall top, a wall bottom, a first end and a second end;
a plurality of securing articles; and
a plurality of mounting articles, wherein the plurality of mounting articles are configured to be securely associated with the wall rear surface of each of the first precast concrete wall, second precast concrete wall, third precast concrete wall and fourth precast concrete wall and wherein the plurality of securing articles are configured to securely associate with the plurality of mounting articles.

11. The support riser of claim 10, wherein one of the plurality of mounting articles is located proximate to each of the corners of the first precast concrete wall, second precast concrete wall, third precast concrete wall and fourth precast concrete wall.

12. The support riser of claim 10, wherein each of the plurality of mounting articles includes an article head and an article shaft, wherein the article shaft includes a threaded portion configured to threadingly engage with the plurality of threaded dowel cavities.

13. The support riser of claim 10, wherein each of the plurality of securing articles includes a first interface surface defining a first interface cavity and a second interface surface defining a second interface cavity.

14. The support riser of claim 13, wherein the first interface surface is substantially perpendicular to the second interface surface.

15. The support riser of claim 13, wherein each of the first interface cavity and the second interface cavity includes a seating portion configured to contain at least a portion of the article shaft.

16. The support riser of claim 13, wherein each of the first precast concrete wall, second precast concrete wall, third precast concrete wall and fourth precast concrete wall includes a first end and a second end and wherein,
the second end of the first precast concrete wall is located proximate to the first end of the second precast concrete wall such that the first precast concrete wall is substantially perpendicular to the second precast concrete wall,
the second end of the second precast concrete wall is located proximate to the first end of the third precast concrete wall such that the second precast concrete wall is substantially perpendicular to the third precast concrete wall,
the second end of the third precast concrete wall is located proximate to the first end of the fourth precast concrete wall such that the third precast concrete wall is substantially perpendicular to the fourth precast concrete wall, and
the second end of the fourth precast concrete wall is located proximate to the first end of the first precast concrete wall such that the fourth precast concrete wall is substantially perpendicular to the first precast concrete wall.

17. The support riser of claim 13, wherein,
the first precast concrete wall is securely associated with the second and fourth precast concrete walls via at least one securing article, and
the third wall is securely associated with the second and fourth walls via at least one securing article.

18. The support riser of claim 10, further including an article support pad configured to be associated with the wall top of the first precast concrete wall, second precast concrete wall, third precast concrete wall and fourth precast concrete wall to be supported by the first precast concrete wall, second precast concrete wall, third precast concrete wall and fourth precast concrete wall.

19. A method for assembling and implementing a precast concrete support riser, wherein the precast concrete support article includes a first precast concrete wall, a second precast concrete wall, a third precast concrete wall, and a fourth precast concrete wall, the method comprising:
identifying a location for the precast concrete support article;
positioning the first precast concrete wall, second precast concrete wall, third precast concrete wall, and fourth precast concrete wall at the location;
associating the first and third precast concrete walls with the second and fourth precast concrete walls such that the first precast concrete wall, second precast concrete wall, third precast concrete wall, and fourth precast concrete wall form a quadrilateral structure having an inner cavity;
associating an article support pad with the first precast concrete wall, second precast concrete wall, third precast concrete wall, and fourth precast concrete wall such that the article support pad is located proximate the top of the first precast concrete wall, second precast concrete wall, third precast concrete wall and fourth precast concrete wall; and
locating an article to be supported on the article support pad.

20. The method of claim 19, wherein the location has a finished grade elevation and wherein the method further comprises:
excavating the location to a depth of approximately 6 inches below the finished grade elevation to create an excavated location;
locating the first precast concrete wall, second precast concrete wall, third precast concrete wall and fourth precast concrete wall within the excavated location;
placing fill material within the excavated location such that fill material is located external to the precast concrete support article and within the inner cavity.
